(19) United States
(12) Patent Application Publication
(10) Pub. No.: US 2007/0105235 A1
(43) Pub. Date: May 10, 2007

(54) Osmium-based oxygen sensor and pressure-sensitive paint

(76) Inventors: William Brenden Carlson, Seattle, WA (US); Gregory D. Phelan, Seattle, WA (US); Jason B. Benedict, Seattle, WA (US); Werner Kaminsky, Seattle, WA (US); Gamal-Eddin Khalil, Redmond, WA (US); Martin P. Gouterman, Seattle, WA (US); Larry R. Dalton, Silverdale, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/355,504

(22) Filed: Feb. 16, 2006

Related U.S. Application Data
(60) Provisional application No. 60/653,906, filed on Feb. 16, 2005.

(51) Int. Cl. G01N 21/75

(52) U.S. Cl. 436/166

(57) ABSTRACT

Osmium-based oxygen sensor, pressure-sensitive paint that includes the osmium-based oxygen sensor, and method for measuring the pressure of an oxygen-containing fluid on a surface using the pressure-sensitive paint.

### CROSS-REFERENCE TO RELATED APPLICATION

The application claims the benefit of U.S. Provisional Patent Application No. 60/653,906, filed Feb. 16, 2005, expressly incorporated herein by reference in its entirety.

### STATEMENT OF GOVERNMENT LICENSE RIGHTS

This invention was made with government support under Contract Number F49620-01-0364, awarded by the Air Force Office of Scientific Research. The government has certain rights in the invention.

### SUMMARY

In one aspect, the present invention provides osmium complexes and paints that include the osmium complexes. In one embodiment, the invention provides a composition, comprising:

(a) a luminescent osmium complex having the formula
[Os(II)(N—N)₂L-L]²⁺, 2A⁻ or A²⁻

wherein

Os(II) is divalent osmium;

N—N is a substituted or unsubstituted 1,10-phenanthroline ligand;

L-L is cis-1,2-bis(diphenylarseno)ethylene, or cis-1,2-bis(diphenylphosphino)-ethylene; and

A is a counter ion; and

(b) an oxygen-permeable host material.

In one embodiment, N—N is 1,10-phenanthroline.

In one embodiment, N—N is 4,7-bis(p-methoxyphenyl)-1,10-phenanthroline.

In one embodiment, N—N is 3,4,7,8-tetramethyl-1,10-phenanthroline.

In one embodiment, the host is poly(2-[ethyl[(heptadecafluorooctyl)sulfonyl]-amino]ethylmethacrylate).

In another aspect of the invention, a method for measuring the pressure of an oxygen-containing fluid on a surface is provided. In one embodiment of the method, an oxygen-containing fluid is flowed over a surface coated with a composition comprising:

(a) a luminescent osmium complex having the formula
[Os(II)(N—N)₂L-L]²⁺, 2A⁻ or A²⁻

wherein

Os(II) is divalent osmium;

N—N is a substituted or unsubstituted 1,10-phenanthroline ligand;

L-L is cis-1,2-bis(diphenylarseno)ethylene, or cis-1,2-bis(diphenylphosphino)-ethylene; and

A is a counter ion; and

(b) an oxygen-permeable host material.

At least a portion of the surface is illuminated with light having a wavelength sufficient to effect luminescent emission from the osmium complex, and the luminescent emission intensity of the osmium complex is measured.

In one embodiment, the surface is an aerodynamic surface.

In one embodiment, the surface is an airfoil, rotor, propeller, fixed-wing, turbine blade, nacelle, aircraft, or missile.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1: False color image of PSP pressure mapping. Blue expresses regions of low pressure while red expresses regions of higher pressure.

FIG. 2: Sketch of possible bonding scenarios involving phosphine (arsine, antimony) ligands.

FIG. 3: Structure of the osmium complexes being utilized for PSP.

FIG. 4: Crystal structure of cis-1,2-vinylenebis(diphenylarsine) grown from heptane with 50% probability spheres. Hydrogen removed for clarity.

FIG. 5: Crystal structure of complex 2, [osmium(1,10-phenanthroline)2cis-1,2-bis(diphenylphosphino)ethene]²⁺, with 50% probability spheres. Solvent, hydrogens, and counter ions removed for clarity.

FIG. 6: Crystal structure of complex 6, [osmium(3,4,7,8-tetramethyl-1,10-phenanthroline)₂cis-1,2-bis(diphenylphosphino)ethene²⁺, with 50% probability spheres. Solvent, hydrogens, and counter ions removed for clarity.

FIG. 7: Crystal structure of complex 1, [osmium(1,10-phenanthroline)₂cis-1,2-vinylenebis(diphenylarsine)]²⁺, with 50% probability spheres. Solvent, hydrogens, and counter ions removed for clarity.

FIG. 8: Crystal structure of complex 3, [osmium(4,7-bis(4-methoxyphenyl)-1,10-phenanthroline)₂cis-1,2-vinylenebis(diphenylarsine)]²⁺, with 50% probability spheres. Solvent, hydrogens, and counter ions removed for clarity.

FIG. 9: Crystal structure of complex 5, [osmium(3,4,7,8-tetramethyl-1,10-phenanthroline)₂cis-1,2-vinylenebis(diphenylarsine)]²⁺, with 50% probability spheres. Solvent, hydrogens, and counter ions removed for clarity.

FIG. 10: Absorption of complex 1, complex 2, complex 5, and complex 6.

FIG. 11: Emission spectra of complex 1, complex 2, complex 5, and complex 6.

FIG. 12: Lifetime measurement of complex 1(●) and complex 5(*).

FIG. 13: Stem-Volmer plot measured at 25° C. for rubth(+), complex 1(♦), complex 2(◯), complex 3(−), complex 4(X), complex 5(*), and complex 6(▴).

FIG. 14: Temperature dependence of phosphorescence intensity for rubth(Ω), complex 1(♦), complex 2(▴), complex 3(X), complex 5(+), complex 6(*).

FIG. 15: Photo-degradation of three complexes used in this study: rubth (♦), complex 5(Δ), and complex 6(◯).

FIG. 16: Consequence for the relative energies of the excited states to each other.

FIG. 17: Crystal and chemical structure of [osmium bis(3,4,7,8-tetramethyl-1,10-phenanthroline) 1,2-bis(dimethylphosphino)ethane]²⁺bis(hexafluorophosphate).

FIG. 18: Pressure dependence of the complex shown in FIG. 17 in a PSP formed with a fluoroacrylic polymer (FAB). Observed increased dynamic range from other osmium complexes. The dynamic range was almost 60%.

FIG. 19: Temperature dependence of the complex shown in FIG. 17 having a loss in intensity per degree rise of about 0.22%.

FIG. 20: Degradation of the complex shown in FIG. 17 in a PSP; only about 2% with an excitation of 700 μw cm⁻² at 400 nm.

FIG. 21: Absorbance spectrum of the complex shown in FIG. 17 having an absorptivity of 76,000 L mol⁻¹ cm⁻¹ at 270 nm and featured absorption bands up to 500 nm.

FIG. 22: Emission spectrum of the complex shown in FIG. 17; quantum yield was measured to be 16% and the lifetime was measured to be 2400 nanoseconds.

FIG. 23: Crystal and chemical structure of osmium(1,2-phenylenebis[dimethylarsine])₂4,7-diphenyl-1,10-phenanthroline hexafluorophosphate.

FIG. 24: Stem-Volmer plot of the complex shown in FIG. 23 in a PSP (FAB).

FIG. 25: Temperature dependence of the complex shown in FIG. 23.

FIG. 26: Absorbance spectrum of the complex shown in FIG. 23.

FIG. 27: Emission spectrum of the complex shown in FIG. 23.

FIG. 28: Chemical structure of osmium (3,4,7,8-tetramethyl-1,10-phenanthroline)₂1,2-phenylenebis(dimethylarsine)hexafluorophosphate.

FIG. 29: Stem-Volmer plot of the complex shown in FIG. 28 in a PSP (FAB). Pressure sensitivity has a full 60% dynamic range.

FIG. 30: Temperature dependence of the complex shown in FIG. 28.

FIG. 31: Degradation of the complex shown in FIG. 28 in a PSP (FAB) at 50° C. (decrease observed after 40 minutes due to lamp fluctuations).

FIG. 32: Absorbance spectrum of the complex shown in FIG. 28.

FIG. 33: Emission spectrum of the complex shown in FIG. 28.

FIG. 34: Stern-Volmer plot of osmium (3,4,7,8-tetramethyl-1,10-phenanthroline)₂1,2-phenylenebis(dimethylarsine)heptafluorobutyrate in a PSP (FIB).

FIG. 35: Temperature dependence of osmium (3,4,7,8-tetramethyl-1,10-phenanthroline)₂1,2-phenylenebis(dimethylarsine)heptafluorobutyrate in a PSP (FIB).

### DETAILED DESCRIPTION

Pressure sensitive paints (PSP) have proved to be revolutionary in the design of aircraft, cars, trucks, and other vehicles. The present invention provides highly phosphorescent divalent osmium complexes incorporated into PSP. The divalent osmium complexes were of the form [Os(N—N)₂L-L](PF₆⁻)₂ where N—N was a derivative of 1,10-phenanthroline, and L-L was either cis-1,2-bis(diphenylphosphino)ethene or cis-1,2-vinylenebis(diphenylarsine). X-ray structures were determined for three complexes and for the free cis-1,2-vinylenebis(diphenylarsine) (dpaene). It was observed that the P—C bond lengths, and C—P—C bond angles do not change significantly when complexed to osmium. It was observed the As—C bond lengths shorten by 2.3 pm and the C—As—C bond angles broaden by 5.6 degrees when complexed to osmium. These changes in the arsine structure may indicate a different method of backbonding between arsenic and osmium. The complexes were dissolved into poly(2-[ethyl[(heptadecafluorooctyl)sulfonyl]amino]ethylmethacrylate) (FAB) at a concentration of 1 mg complex to 1000 mg of polymer. The luminescence of the paints was tested for pressure sensitivity, temperature dependence, and photo-degradation. The paints featured strong pressure response, and luminescence intensity changed by up to a factor of two. The temperature dependence of the luminescence was measured as low as −0.17% ° C.⁻¹. The complexes exhibited almost non-existent photo-degradation. These attributes make these complexes very desirable luminescent dyes for PSP.

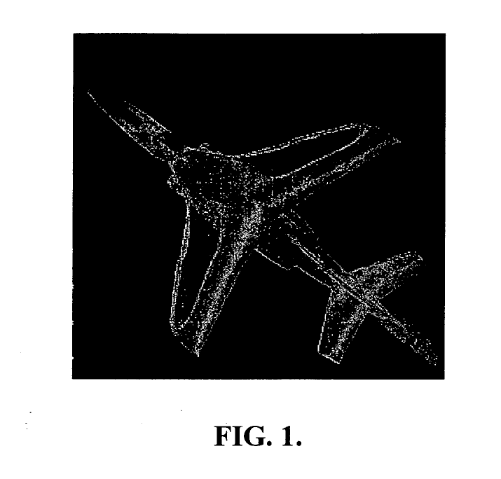

Pressure sensing paint (PSP) consists of a luminescent dye whose emissive properties vary as a function of pressure dissolved in polymer host material. These two components may be applied by either spray or brush when dissolved into a suitable solvent. Quenching of the dye by oxygen leads to changes in intensity that may be correlated to changes in pressure. This technology has revolutionized the way that aircraft are developed. Since its initial conception, PSP has also begun to show tremendous utility in non-aerodynamic fields such as medicine, beer manufacturing, and anywhere else that either the pressure or the oxygen concentration needs to be known. The need for more efficient method for pressure measurement in the development of vehicles was the main source of support for the development of PSP. This is due to the fact that the pressure contours around a moving vehicle determines how efficiently that vehicle operates. For example, the distribution of the lift (changes in pressure) on an airfoil is crucial in wing design, and PSP allows this to be mapped (FIG. 1). In the future PSP may be used for drag studies, allowing manufactures to increase efficiency before full-scale production of the actual vehicle. This allows for less fuel to be burned while increasing payloads. Examples of vehicles whose development was aided by PSP include the Boeing 777 and next generation 737's, and various cars and trucks such as those made by Ford.

Despite the successful use of PSP, there are still issues that need to be addressed before quantitative measurements may be made with PSP. Ideally, PSP should only exhibit changes in luminescence intensity as a function of pressure or oxygen concentration. However, there are other processes that may lead to changes in luminescence intensity other than pressure. These are called temperature dependence and photo-degradation of the PSP, and they lead to errors in the pressure measurement. The temperature dependence is the change (usually loss) of emission with increasing temperature. Photo-degradation may be described as the chemical decomposition of the dye when exposed to light.

Because phosphorescent materials generally possess longer lived excited states, more oxygen quenching takes place and leads to greater pressure sensitivity. Several phosphorescent materials have been used for PSP, these include the porphyrin complexes of palladium and platinum, and other complexes utilizing Ir, or Ru. Heavy metals are typically used as the luminophores since the large spin-orbit coupling constants afford a break down in the spin selection rules and allows for rapid intersystem crossing to the triplet state. Phosphorescent dyes have been dissolved into a variety of host materials. For example poly(dimethylsiloxane) RTV's, trimethylsilyl propyne, fluoroacrylic polymers, or making the dye part of the polymer itself have all been used in PSP. In the present invention, fluoroacrylic polymers were used as the host material.

There are several excited states for metal complexes. The excited states are the ligand-centered state, metal centered state, and the charge transfer state. The ligand-centered (LC) state may be defined as transitions such as π-π* that take place on the ligand. For a complex with an octahedral coordination sphere such as the ones being presented in this discussion, the metal centered (MC) state may be defined as a transition between filled d_{xy}, d_{xz}, d_{yz} (dπ) and the empty d_{z}², dₓ²-_{y}² (dσ*). Charge transfer states may be defined as a transfer of charge from either a filled metal orbital to an empty orbital on the ligand, or from filled ligand orbitals to empty orbitals on the metal. For the complexes being discussed in this report, the charge transfer bands may be called metal to ligand charge transfer (MLCT) and defined by a transition between filled dπ orbitals and empty π* orbitals on the ligand (dπ_{Os}→π*ₚₕₑₙ). Of these states, the MLCT and the LC states may be luminescent; however, the MC state is usually not luminescent. Thus, it may be desirable to increase the energy of MC state as much as possible as to reduce the probability of the state becoming populated. Furthermore, increasing the energy separation of the MC state from the lower energy LC and/or MLCT emitting states may reduce temperature dependence and photo-degradation of the complexes. The energies of LC, MC, and MLCT states may be varied by changing the either metal, the type of ligands used, or both. Thus, to successfully design phosphorescent dyes for PSP, and understanding of the bonding between metal and ligands in complexes is needed.

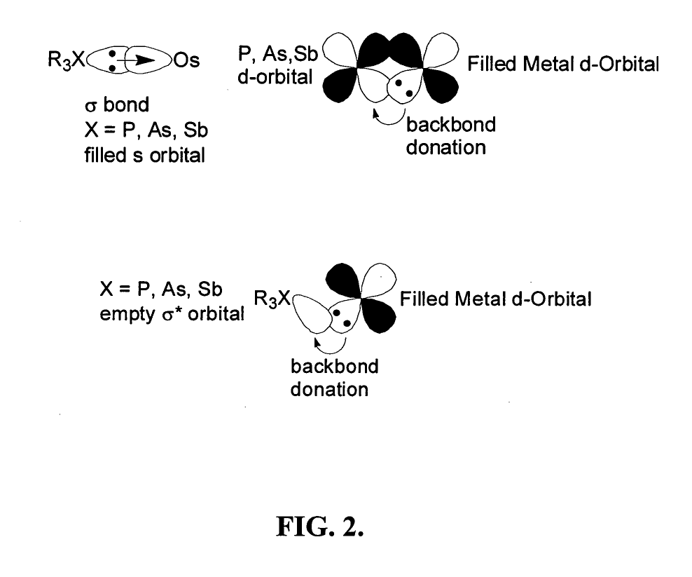

The bonding in arsine (phosphine, antimony) ligand containing metal complexes may be thought of as having two major components. There is σ donation of the lone pair contained in the s orbital on the arsenic (phosphorus, antimony) ligand to an empty d orbital on the metal (FIG. 2). For complexes in octahedral coordination, as is the case for the osmium complexes being discussed in this report, the donation of the ligand lone pair is to the d_{z}² and the dₓ²_{-y}². The other component is called backbonding. This occurs by backdonation from a filled d orbital on the metal (d_{xy}, d_{xz}, d_{yz}) to an empty orbital on the phosphorus. The question arises as to which orbital on the arsenic is responsible for accepting the back donation from the metal since there are no apparent orbitals to accept charge. This accepting orbital has been described as being either a d-orbital or an antibonding σ orbital; current consensus is that the latter is more appropriate. Some crystallographic reports have shown that the bond lengths between phosphorus/arsenic and the R groups attached to it lengthen, which supports the notion that a σ* is responsible for backbonding with the metal. It has been generally accepted that the phosphine/arsine ligands backbond strongly when based upon strongly electron withdrawing groups such as fluorine. With the AsF₃ ligand it has been shown that bond lengths increase 4 pm (due to σ* backbonding) while bond angles remain unchanged at 95°. Ligands with more electron donating groups such as methyl tend to be stronger sigma donors and backbond more weakly. Data suggests that σ* backbonding is not taking place and the complexes being presented may be an example of metal d-ligand d backbonding.

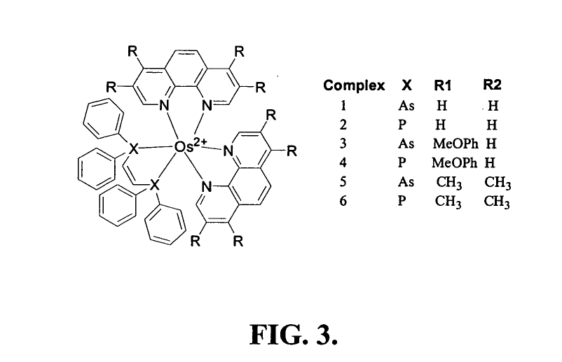

The concepts of metal and ligand chemistry are used to develop improved PSP utilizing divalent osmium complexes (FIG. 3). The PSP exhibit reduced photo-degradation and temperature dependence, while maintaining pressure sensitivity similar to that of ruthenium complexes.

Structure of cis-1,2-bis(diphenylphosphino)ethene (dppene) and cis-1,2-vinylenebis(dipheylarsine) (dpaene). The structure of dppene has been previously reported: the C—P bond length was 181.5 pm to the bridge, and 182.9 and 183.9 pm to the phenyl groups. The average P—C bond length for dppene was found to be 183.1(6). The average C—P—C bond angle was found to be 102.0(5) degrees.

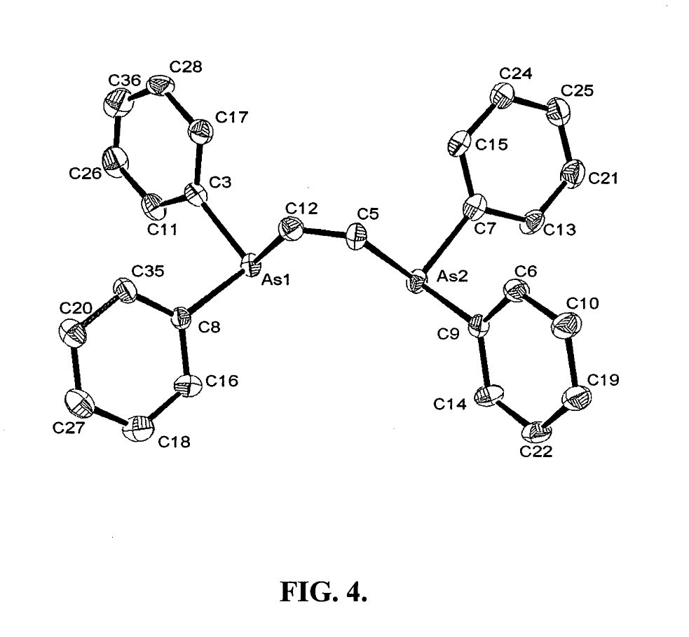

A structure of dpaene was obtained from crystals that were grown from 1-butanol. The structure had significant disorder, which greatly increased the standard deviation of the bond lengths and angles. This made meaningful comparisons between the dpaene structure and the metal complexes derived from dpaene difficult. Crystals of dpaene without disorder were obtained from a dilute heptane solution giving a lower standard deviation than previously reported (FIG. 4). The crystallographic refinement parameters are tabulated in Table 1. Bond angles and lengths are tabulated in Tables 2-3. The non-disordered structure closely agrees with the major (88.9%) structure of the previous report; thus, the structure grown from heptane was averaged with the major structure grown from butanol. The average As—C bond length was 196.3(11) pm. This result is slightly shorter the expected bond length of 198 pm based upon the covalent radii of arsenic (121 pm) and carbon (77 pm). The average C—As—C bond angle was observed to be 97.3(12) degrees, considerably more acute than that of a tetrahedral structure where the ideal bond angle would be 109.5 degrees. It has been previously reported that a reluctance exists for arsenic to hybridize, forming bonds with orthogonal p orbitals. The “lone pair” does not reside in an orbital of “sp” character, rather an orbital that is of more s character.

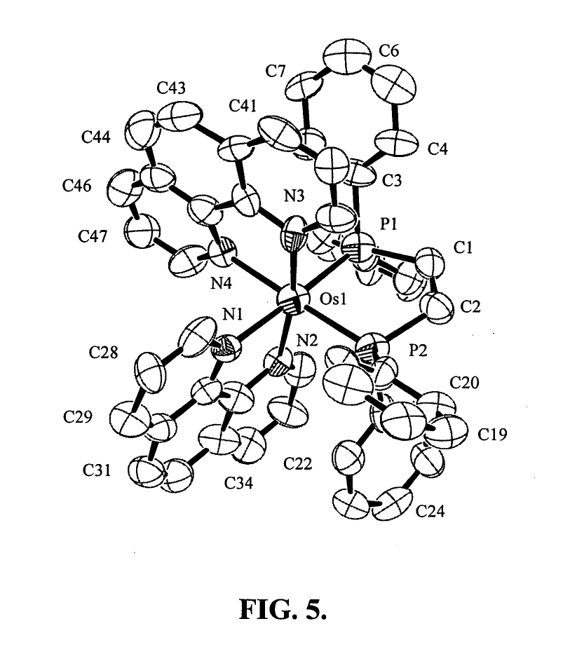

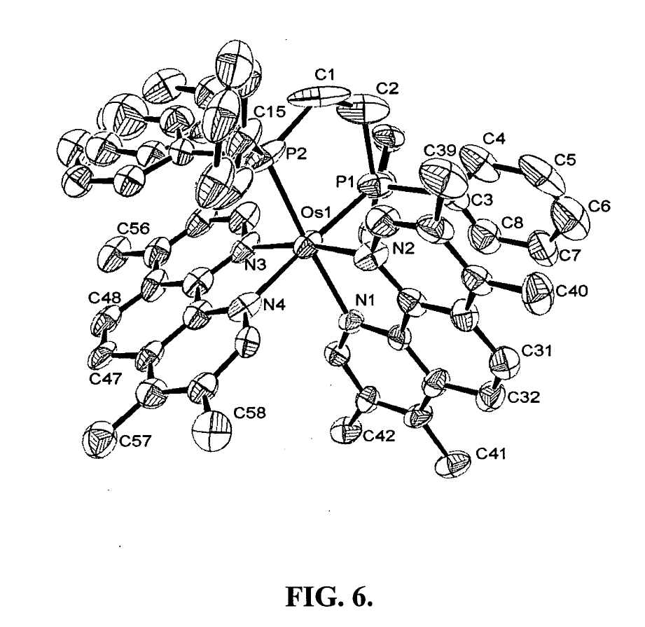

Structure of dppene and dpaene containing complexes. X-ray structures for complexes 2 and 6 are illustrated in FIGS. 5 and 6. The crystallographic refinement parameters are tabulated in Table 1. The result closely resembles the previous results. The average Os—P bonds length was 229.3(8) pm, which was ˜13 pm shorter than what would be expected for a single bond based upon the covalent radii of osmium (133 pm) and phosphorous (110 pm). The average P—C bond of the complexed dppene ligand was 182.8(15) pm. The C—P—C bond angles for the complex were 102.8(14) degrees.

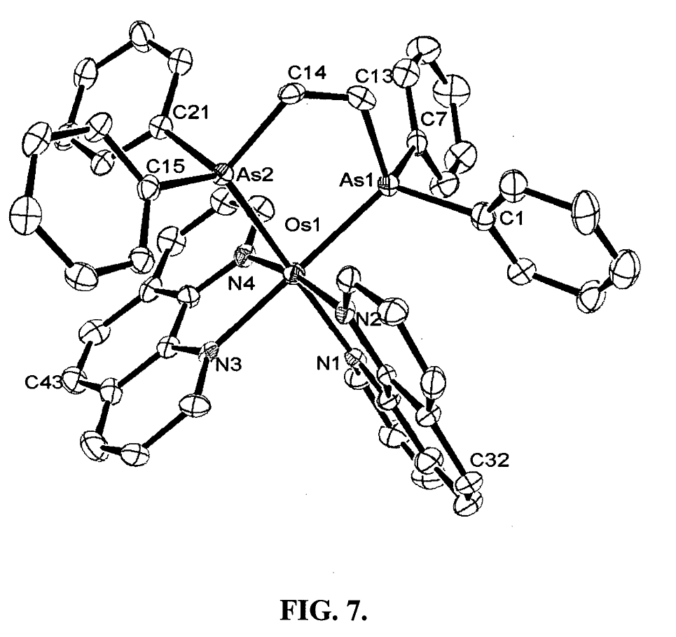

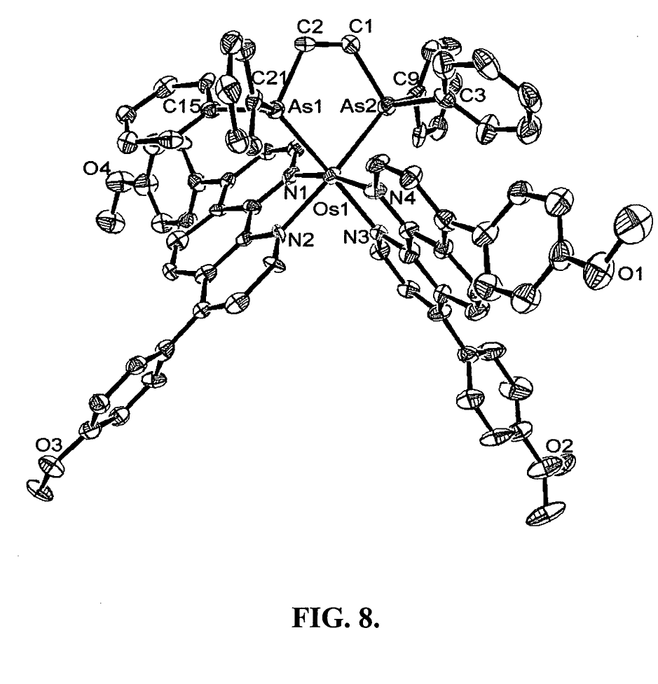

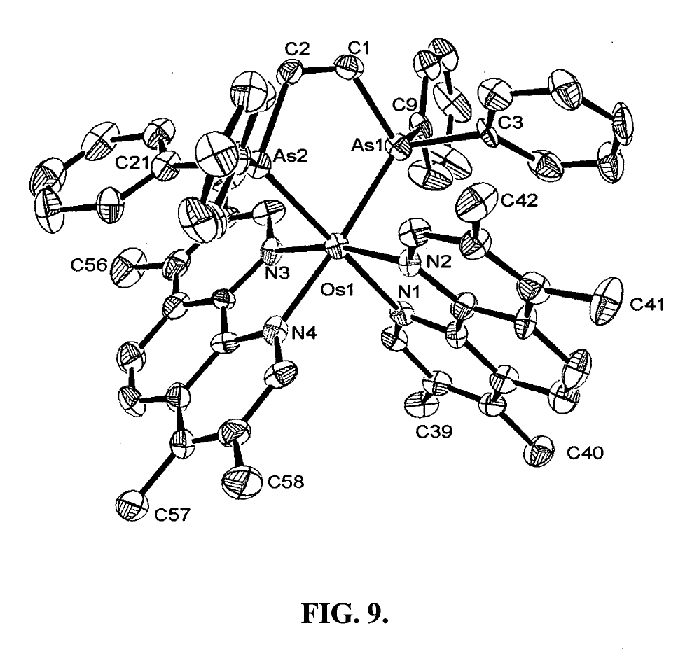

X-ray structures are given for complexes 1, 3, and 5 are illustrated in FIGS. 7-9. The crystallographic refinement parameters are tabulated in Table 1. For the complexes the average C—As—C bond angle was observed to be 102.9(14) degrees (Table 2). The average lengths (Table 3) of the Os—N, Os—As, and As—C bonds were measured to be 208.8(27) pm, 240.9(6), and 194.0(9) pm. The As—Os bonds were ˜13 pm shorter than what would be expected for a single bond based upon the covalent radii of the atoms: arsenic (121 pm), osmium (133 pm).

Nature of bonding of dppene and dpaene complexed to osmium. The behavior of dppene and dpaene when complexed to osmium were observed to be different from each other. Dppene when complexed to osmium was observed to undergo very little, if any, structural change. For the dppene system, both the C—P bond lengths and C—P—C bond angles were well within standard deviation of the free ligand. However, dpaene was observed to undergo significant structural change when complexed to osmium. The difference in behavior between dppene and dpaene may be explained by the σ and π contributions of the ligand-Os bonds.

Os-ligand π bonds through the π system of the bridging unit may be possible. For each of the complexes the C═C bond length was measured to be: complex 1 complex 3 [129.3(12) pm], complex 5 [130.8(9) pm], DMB [132.7(10) pm], and DPB [129.6(11) pm], all of which were normal for a C═C bond, and similar to the C═C bond in the free dpaene structure, which was measured to be 133(1) pm. This is evidence for little participation, if any, of the C═C bond in the complexation to osmium, and very little strain being placed upon this bond by complexing the dpaene ligand to the metal. The 71 system of the phenyls may also participate in receiving electron density from the filled d orbital of the metal, but due to the distance between the phenyl groups and osmium (365-596 pm), and the lack of proper orientation of the phenyl groups towards the metal, this possibility is remote.

The contributions of σ and π components to metal-phosphorus bonds of PR₃ complexes by measurement of the P—R bond lengths and R—P—R bond angles has been reported. The basis for this was that the π-accepting ability of the phosphorus was a function of the mixing of P—R σ* and the 3d orbitals. Increasing back donation from the metal to the phosphors leads to longer P—R distances and smaller R—P—R angles, whereas the opposite was true for increasing a contribution. For the Os-dppene complexes the two effects cancel; thus, it is observed that the C—P bond lengths and the C—P—C bond angles remain unchanged form those of the free ligand. The 99% confidence interval for the 30 As—C bond lengths of the complexes was 193.6 pm to 194.4 pm, and of the 30 C—As—C bond angles 101.7 to 104.0 degrees. The 99% confidence level for the 12 bond length of the dpaene ligand was 195.5 pm to 197.2 pm, and of the 12 bond angles 96.5 to 98.1 degrees. Thus, to 99% confidence, it may be stated that the As—C bond lengths shorten, and the C—As—C bond angles broaden when the ligand is complexed to osmium. In the same logic with the phosphine complexes, this could be taken as evidence for an increased σ component in the σ/π ratio for the Os—As bond, but this is not in accordance, with the observed data. Both the P—Os and the As—Os bonds exhibit a similar 13 pm shortening in the bond than would be expected; thus, both dppene and dpaene show similar backbonding.

Significant mixing of the As 4d-orbitals into the As—C σ* overlapping with the filled Os 5d-orbitals explain the observed shortening of the As—C bond length and increase C—As—C in the bond angle when complexed to osmium. Similar trends of decreasing C-M bonds and increases in C-M-C bond angles were observed in triphenyl antimony ligands when complexed to platinum. The increase in bond angles in conjunction with a decrease in the sigma bonds was evidence for Sb 5d-Pt 5d orbital overlap leading to backbonding. Thus, the dpaene-osmium complexes being reported may be an example of As 4d-Os 5d backbonding analogous to what was observed for complexes based upon triphenyl antimony.

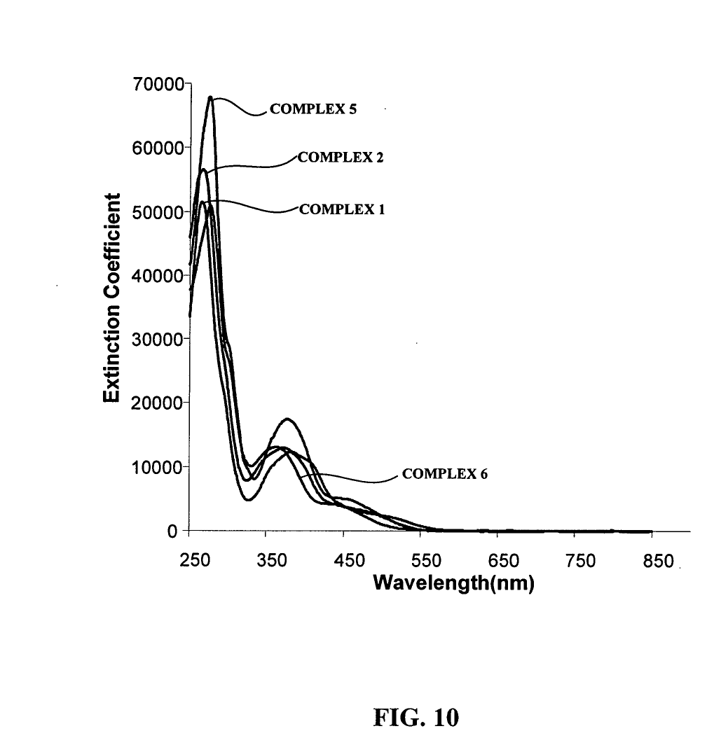

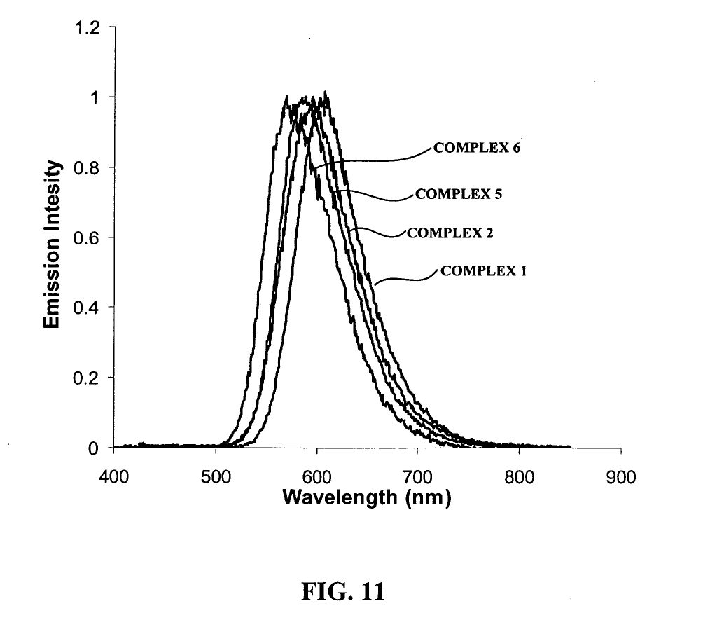

Spectral Properties. The absorbance, emission lifetime, and other spectral properties are tabulated in Table 4, and illustrated in FIGS. 10-11. The orbital transition that defines the MC state (dπ-dσ*) are of orbitals of like symmetry and thus are Laporte forbidden. This transition may be very weak, with ε usually less than 100 L mol⁻¹ cm⁻¹, and thus is “buried” under the much stronger LC and MLCT transitions. The LC transition for the complexes was observed as a sharp peak between 260 and 280 nm. The extinction coefficients were measured to be between 51,000-71,000 L mol⁻¹ cm⁻¹. Two MLCT bands were observed for these complexes. The stronger of the two corresponds to the singlet transition and appears as a somewhat broad transition with a maximum just below 400 nm. The triplet MLCT absorption band appears at 500 nm and arises due to the spin-orbit coupling constant of the heavy osmium center and the strong back bonding metal-ligand orbital intermixing. The singlet MLCT band for the complexes was observed between 364-391 nm (ε=12,000-50,000 L mol⁻¹ cm⁻¹) and the triplet band was observed between 441-500 nm (ε=2,400-9,000 L mol⁻¹ cm⁻¹).

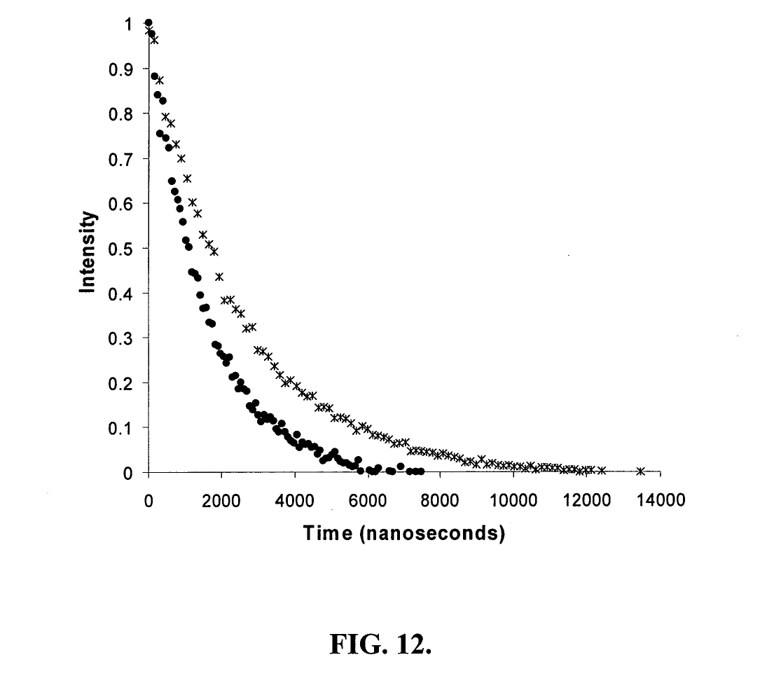

The complexes feature a smooth, unstructured exponential Gaussian emission typical of MLCT. The emission lifetime was measured to range between 1,500-3,400 ns. FIG. 12 illustrates the decay of the luminescent state for complexes 1 and 5. It was observed that tetra-methyl substitution on the phenanthroline structure nearly doubles the emission lifetime. Phenyl substitution in the 4 and 7 positions on the phenanthroline structure has been reported to greatly increase the emission lifetime of ruthenium complexes based upon such ligands. However, for the osmium complexes, the lifetime of the phenyl-substituted complexes (complexes 3 and 4) remains unchanged from that of the unsubstituted phenanthroline complexes (complexes 1 and 2), so the effect was only observed for the tetra-substituted phenanthroline. The arsine complexes, 1, 3, and 5, had consistently shorter emission lifetimes than their phosphine counterparts by 300-500 ns. This observation may be due to the fact that arsenic is heavier than phosphorus, which leads to larger spin-orbit coupling. This would have the effect of increasing the rate of intersystem crossing, which would lead to faster transition rates including phosphorescence.

Emission of the complexes was measured to between 588-629 nm. The emission quantum yields of the complexes were found to range between 0.17-0.26. It was found that substitution on the phenanthroline structure had the effect of increasing quantum yields. This may be due to the decease in C—H bond vibration on the phenanthroline structure. Generally, the complexes with arsine ligands had slightly stronger quantum yields than their phosphine counterparts. Since the arsine complexes have slightly faster lifetimes, it may be that the radiative rate has become more competitive with the non-radiative rate; thus, an increase in emission quantum yields was observed for the arsine complexes.

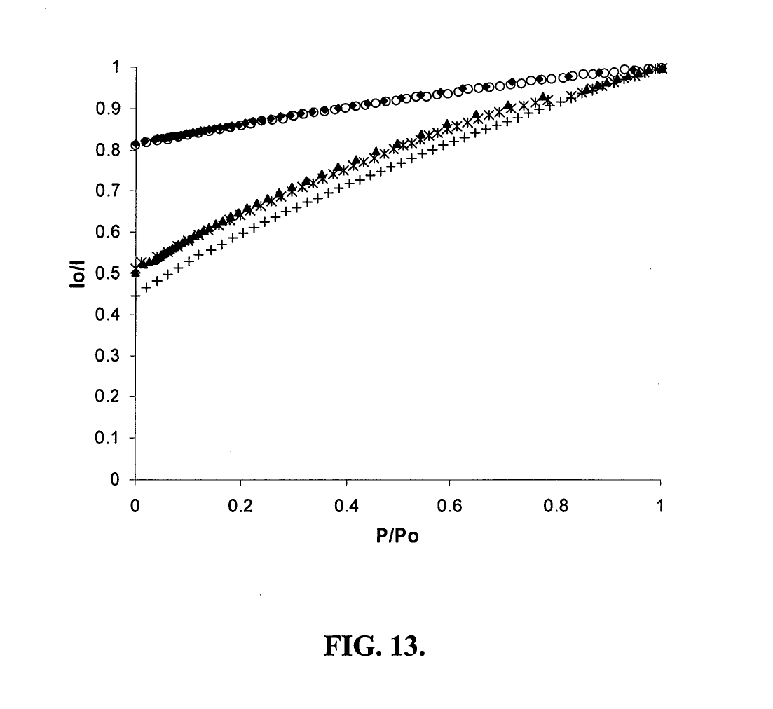

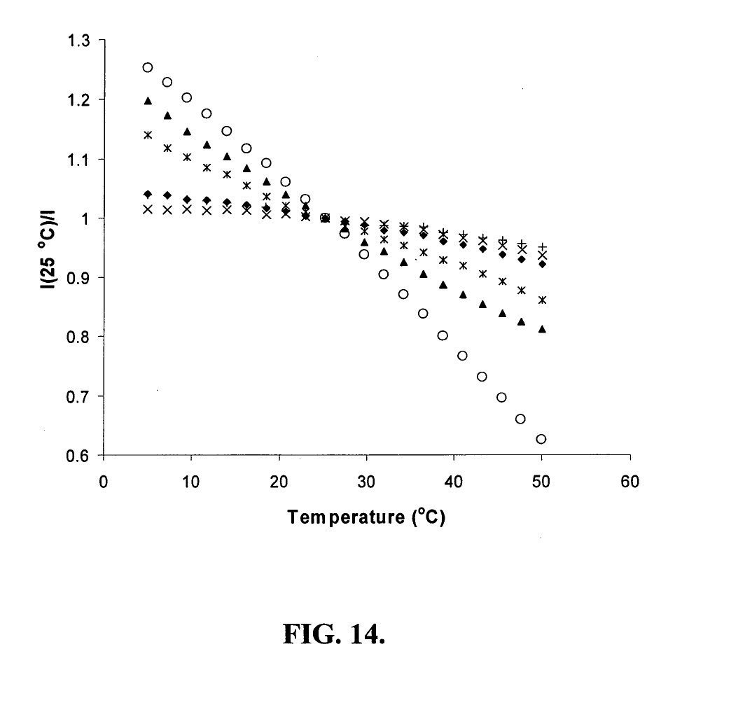

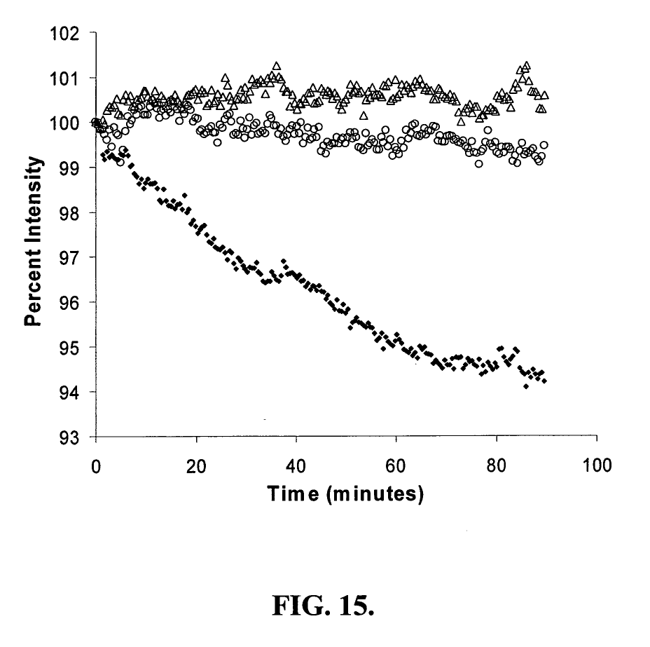

Pressure Sensing Paints. The osmium complexes have been incorporated into PSP and have been tested for pressure sensitivity, temperature dependence, and photo-degradation. These results were compared to ruthenium tris(4,7-diphenyl-1,10-phenanthroline)(PF₆)₂ (rubth) PSP, a phosphorescent dye often used in PSP formulations. A new polymer, FAB was created to offer some of the features of another polymer reported in the literature called FIB, while being a solvent to many phosphorescent dyes that are salts. The ruthenium dye was soluble in the FAB polymer without any additives that could interfere with the stability of the dye. The PF₆⁻ ion was used in this formulation, as this counter ion is much less of a nucleophile than chloride. In the FAB polymer the rubth dye gave a dynamic range of 55% (FIG. 13), but the dye had an inherent temperature dependence of nearly 1.4% ° C.⁻¹ (FIG. 14), and photo-degraded nearly 6% over 90 minutes under 700 μW cm⁻² at 400 nm (fwhm, 20 nm) illumination (FIG. 15).

Six divalent osmium complexes were tested as PSP dyes, and all were used as the PF₆⁻ salt and dissolved in the FAB polymer (Table 5, FIGS. 13-15). The emission lifetimes are reported in Table 2. While complexes 1 and 2 differed in lifetime by 300 nanoseconds, they both gave dynamic range of 19%. These two complexes were based upon the 1,10-phenanthroline ligand. Complexes 3 and 4 based upon 4,7-bis(p-methoxyphenyl)-1,10-phenanthroline both gave similar dynamic ranges of 22% and 25%. And the 3,4,7,8-tetramethyl-1,10-phenanthroline complexes (5 and 6) each gave 50% dynamic range. In fact, these two molecules gave the same dynamic range despite the 600 ns difference in lifetime between them. In addition both gave nearly the same dynamic range as rubth even though the ruthenium complex has a much longer lifetime (˜6 μs). These observations would not have been expected based upon the emission lifetime. This may be due to the area of each molecule. This is evident from the crystal structures. The unit cell lengths (Table 1) of complex 3 range 10-20% larger than that of complex 1. Complexes 3 and 4 have greater area for oxygen to collide with due to the presence of phenyl groups as compared to complexes 1 and 2. This leads to a 15% increase in dynamic range for complexes 3 and 4. The arsine-ligand based complexes have shorter lifetimes than their phosphine counterparts. Despite this, within each grouping, the arsine gives the same dynamic range as shown by the comparisons of 1 vs. 2, 3 vs. 4, and 5 vs. 6. Thus, the quenching constant of the osmium complexes with dpaene was observed to be greater than that of the osmium complexes with dppene. This may be due to the fact that dpaene increases the cross sectional area. This is evident from the crystallography. The Os—As bond was 11 pm longer than the Os—P bond, and the As—C bonds were 10 pm longer than the P—C bonds. This is evident in the volumes of the crystal lattice where complex 1 is slightly larger than complex 2, and complex 5 is slightly larger than complex 6. The result of this would be a slightly larger cross section for the complexes based upon dpaene, leading to a larger quenching constant.

The temperature dependence of the osmium complexes (Table 5) was much reduced from that of rubth. While rubth gave a temperature dependence of −1.4% ° C.⁻¹, the maximum observed for an osmium complex was −0.8% ° C.⁻¹, or nearly half. With phosphine ligands, the temperature dependence of complexes 2, 4, and 6 was found to range from 0.4% to 0.8% ° C.⁻¹. With arsine ligands, the temperature dependence of complexes 1, 3, and 5 was found to range from 0.2% to 0.3% ° C.⁻¹. Of the osmium dyes with the greatest pressure sensitivity, complex 5 gave a temperature dependence of −0.2% ° C.⁻¹ while complex 6 was over −0.8% ° C.⁻¹. Either complex 5 or 6 would have less pressure measurement error due to variations in temperature than rubth, but complex 5 would be much more improved due to the lower temperature dependence.

Every osmium complex exhibited reduced rates of photo-degradation as compared to rubth. Rubth was observed to photo-degrade nearly 6% over 90 minutes where as the osmium complexes exhibited very little or no degradation under the same conditions. It has been reported that a major photo-degradation pathways for ruthenium complexes are the attack of water and singlet oxygen on the polypyridyl structure. Complexes 5 and 6 were observed to exhibit oxygen quenching nearly equivalent to rubth; thus, the singlet oxygen being produced by complexes 5 and 6 would be similar to rubth. Yet, in the presence of similar amounts of singlet oxygen the osmium complexes degraded less than rubth. This could have either two consequences: the metal used in the complex has an effect on the rate of oxygen addition to the polypyridyl structure (osmium slows the rate vs. ruthenium), or that the primary method of photo-degradation is the breaking of metal-ligand bonds.

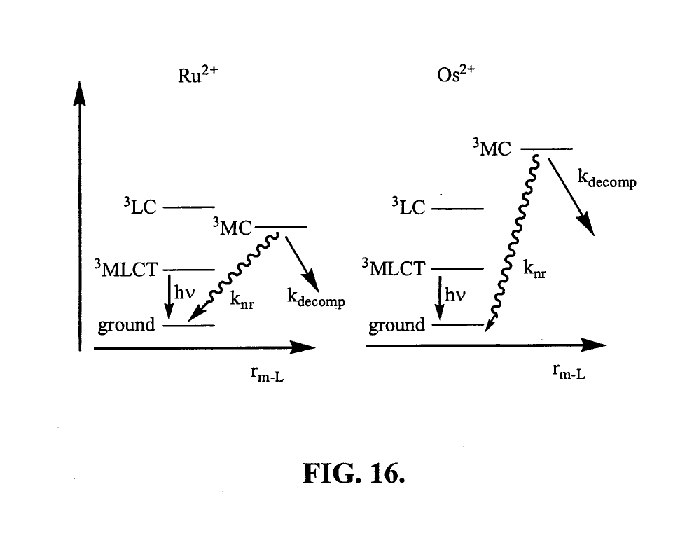

The relative energies of the excited states may explain why it was found that osmium complexes degrade at a slow rate while it ruthenium complexes degrade at a faster rate, and that less temperature dependence was observed for the osmium complexes. These excited states are the MLCT, the MC, and the LC. Each of these states, and their relation to each other in energy, has consequences on the stability and performance of PSP. The MC state may be described as an antibonding state to the metal-ligand a bonds. Thus, when the MC state is populated, the metal-ligand bonds lengthen. From this state the complex may non-radiatively decay back to the ground state, or chemically decompose. FIG. 16 illustrates the effect of the MC state on complex properties. When the energy separation between the MC state and the emitting state is low, the MC state may be thermally populated, and the population of the MC may increase as the temperature increases; hence, temperature dependence. By changing the metal to osmium and the use of stronger field dpaene and dppene ligands, the MC state was increased in energy. Furthermore, the energy separation between the emitting MLCT state and the MC state was increased. The effect of this would be to decrease the population of the MC state, which would decrease the rate of photo-degradation. By increasing the energy separation between the emitting MLCT state and the MC state, thermal population of the MC state was lessened; thus, decreased temperature dependence was observed.

Comparing complexes 1, 3, and 5 with 2, 4, and 6, minor differences in photo-degradation were observed. Usually the dpaene complexes exhibited slightly less photo-degradation than the dppene complexes, which may be a function of the increase in the d participation in the bonding between dpaene and osmium. As the population of a σ* orbital, under the intense excitation illumination, may lead to cleavage of σ bonds, reduction in the population of the σ* may explain the reduction in photo-degradation of the dpaene complexes. The difference in temperature dependence between the dpaene complexes was significant also. This may be due to increased crystal field splitting of the complexes formed with the dpaene ligand. The crystal field splitting is a function of the metal and both the σ and backbonding of the ligand to the metal. Larger crystal field splitting would lead to increased energy separation of the MC state from the emitting states. The increased energy separation would require an increase in thermal energy for population of the MC state; hence, leading to a reduction in temperature dependence.

Osmium complexes of the form [Os(phenanthroline)₂L-L](PF₆)₂ where L-L is either dpaene or dppene have been synthesized and incorporated into PSP with a fluoroacrylic polymer. The results showed that osmium complexes reduce both the temperature dependence and photo-degradation of PSP. Complexes made with the 3,4,7,8-tetramethyl-1,10-phenanthroline ligand exhibited a longer emission lifetime and more oxygen quenching than complexes based upon other derivatives of 1,10-phenanthroline. Complexes based upon the dpaene ligand were observed to have lowest temperature dependence and photo-degradation.

X-ray structures were determined for six osmium structures as well as for the cis-1,2-vinylenebis(diphenylarsine) ligand. It was found that the dppene ligand did not under go structural change when complexed to osmium. It was found that the dpaene ligand did undergo structural change when complexed to osmium. The As—C bond lengths were observed to shorten by 2.3 pm and the C—As—C bond angles broadened by 5.6 degrees. It was determined that backbonding involving the As—C σ* was not consistent with structural data. The structural data may be evidence for increased participation of the As 4d in forming the backbond. The increased d participation may have lead to a reduction in photo-degradation and temperature dependence of the PSP utilizing complexes made with the dpaene ligand.

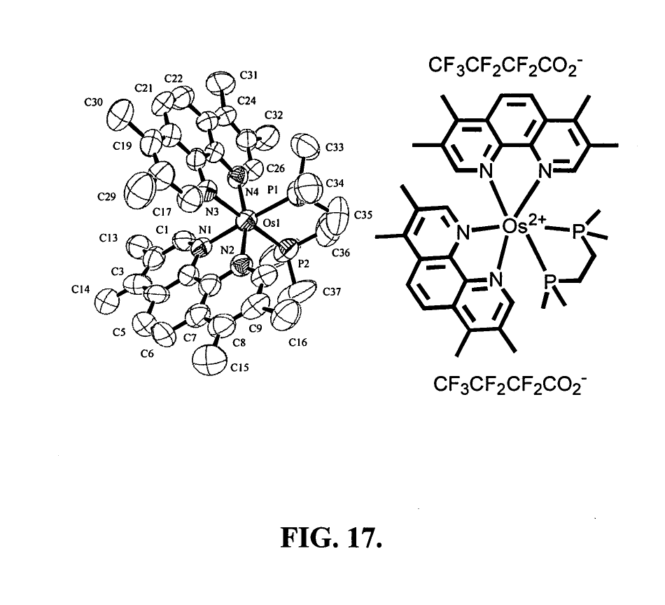

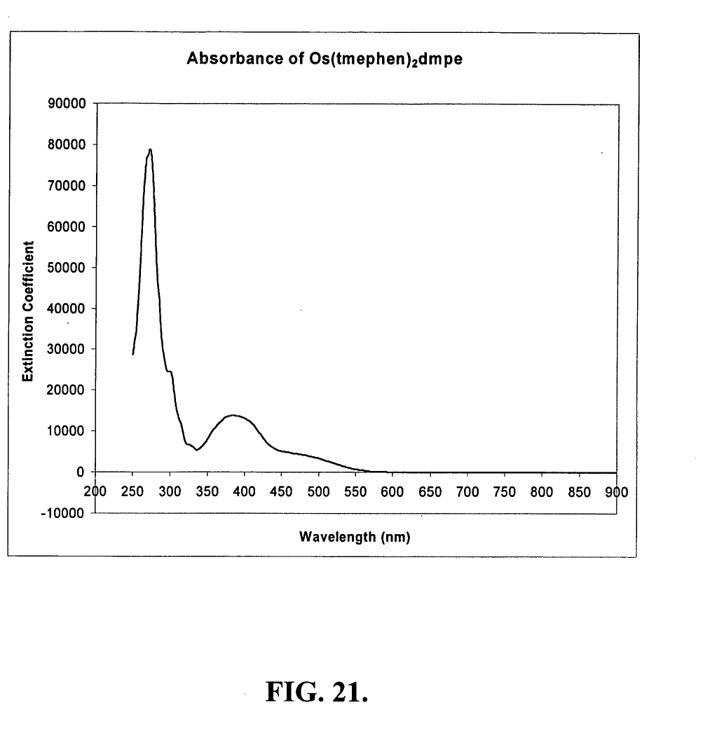

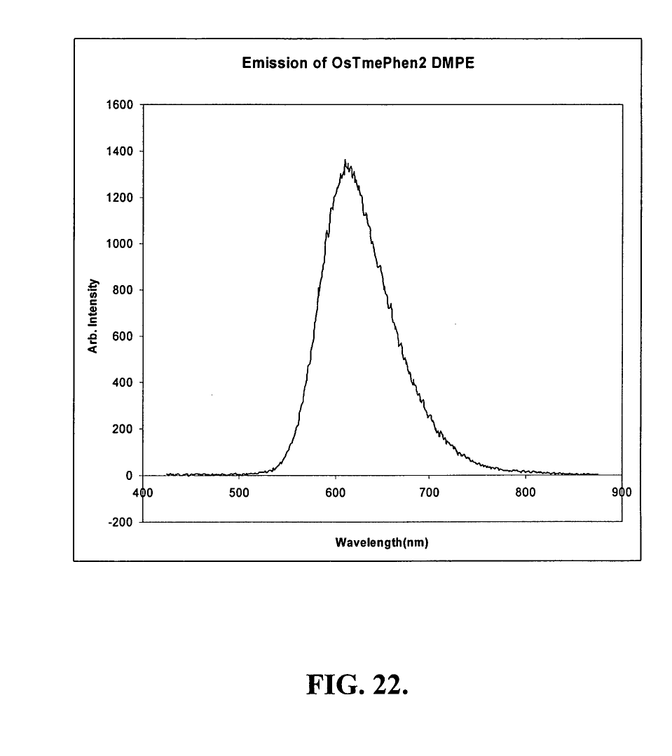

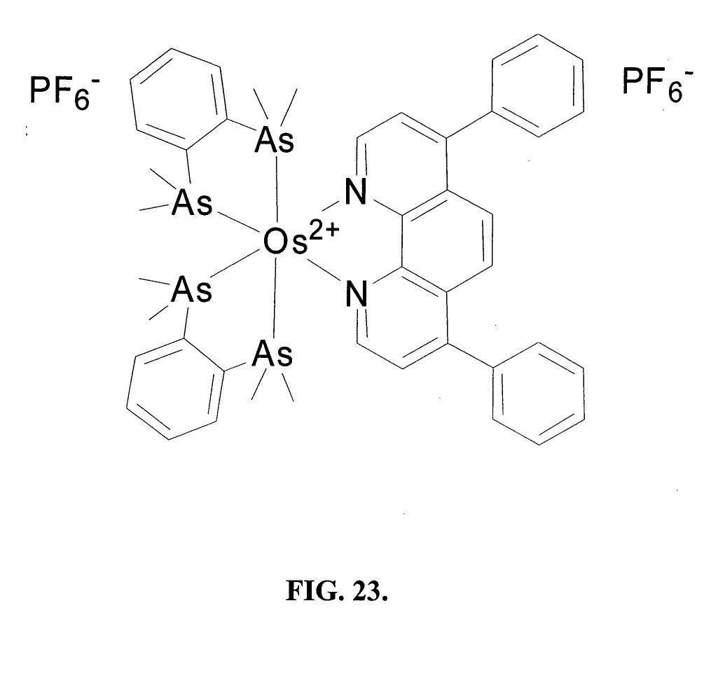

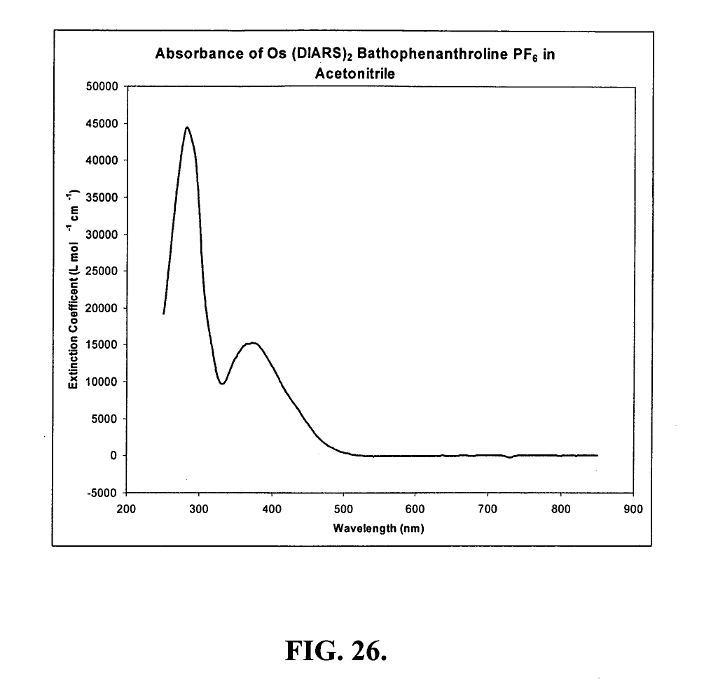

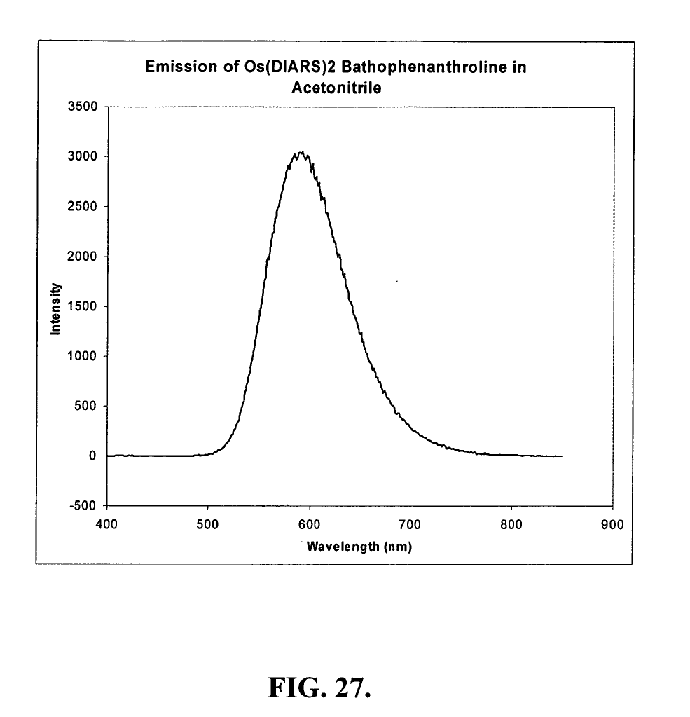

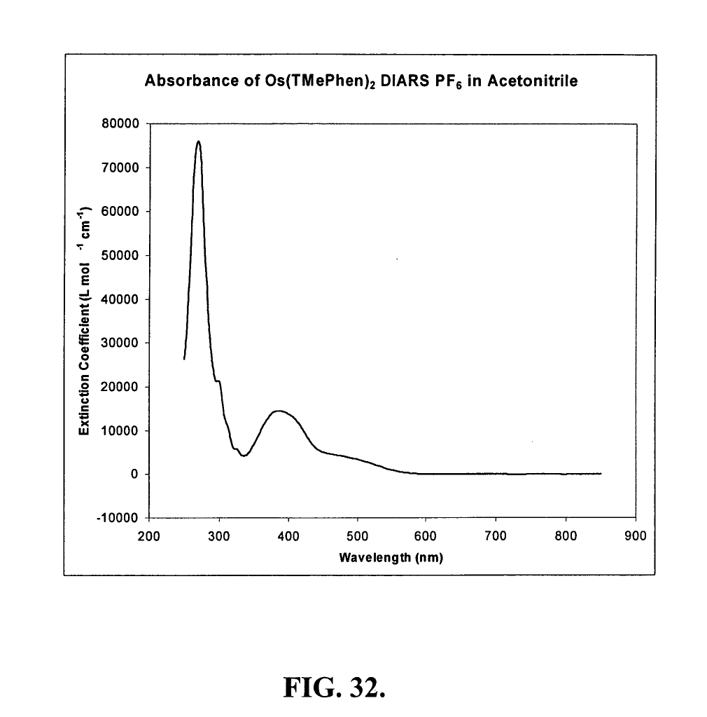

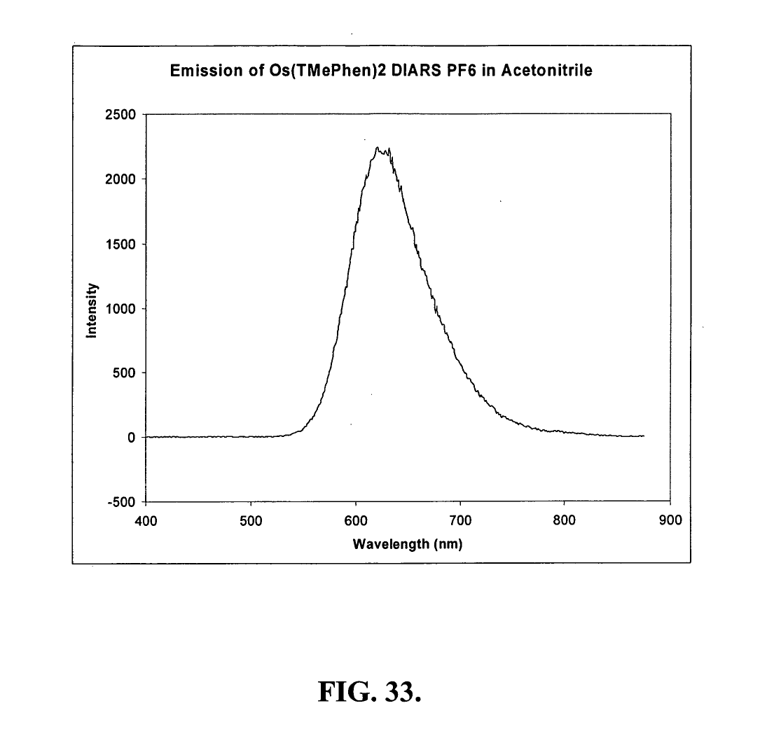

In another aspect of the invention, osmium complexes having the chemical structures illustrated in FIGS. 17, 23, and 28 are provided. The absorbance and emission properties of these complexes are shown in FIGS. 21 and 22, 26 and 27, and 32 and 33, respectively.

PSPs of these complexes were prepared. All paints were prepared using the ratio of 1 mg of complex to 1000 mg of fluoroacrylate (FAB) polymer. The paints were made combining 1 mg of complex and 1000 mg of polymer and then adding 2 mL of acetone. After the complex was dissolved, 18 mL of α,α,α-trifluorotolune was added and the polymer fully dissolved. The paints were sprayed onto 1 inch square aluminum plates and were allowed to dry for 3 days before testing.

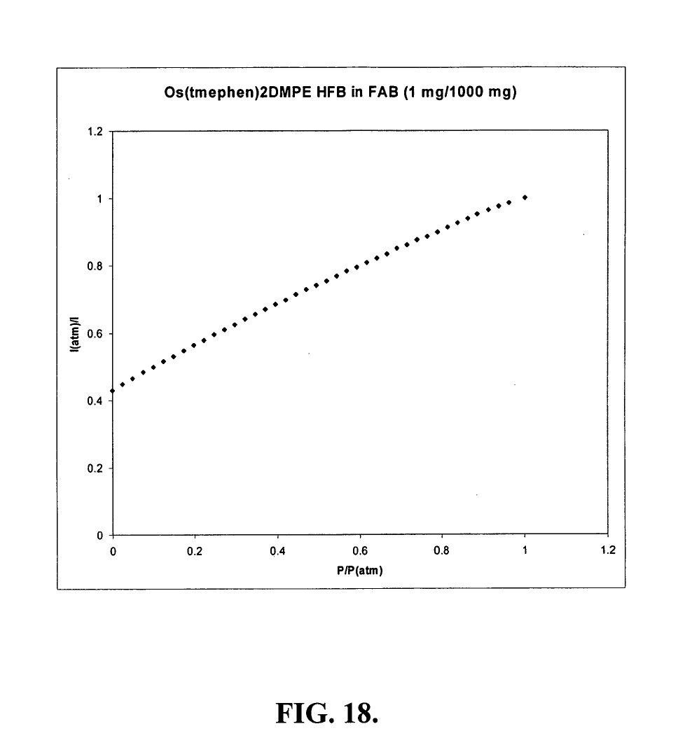

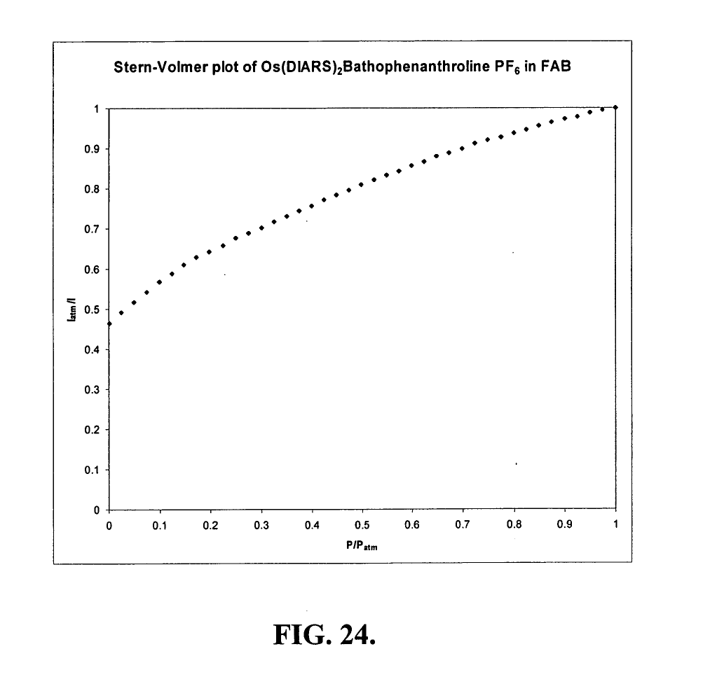

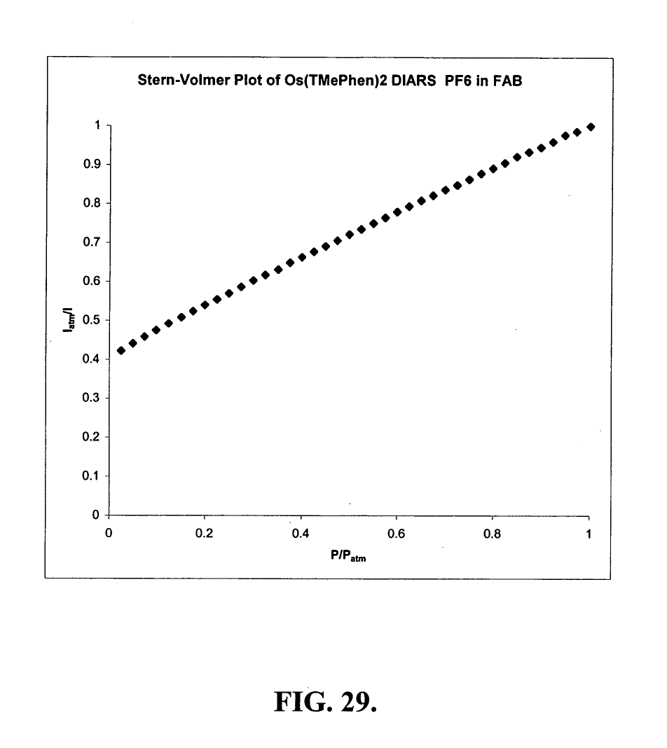

Stem-Volmer plots of these complexes in FAB are shown in FIGS. 18, 24, and 29, respectively.

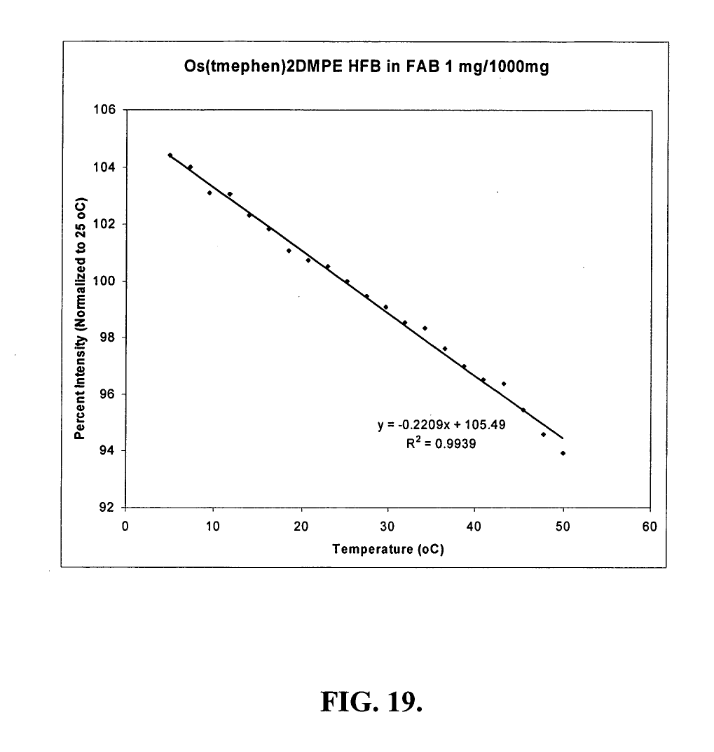

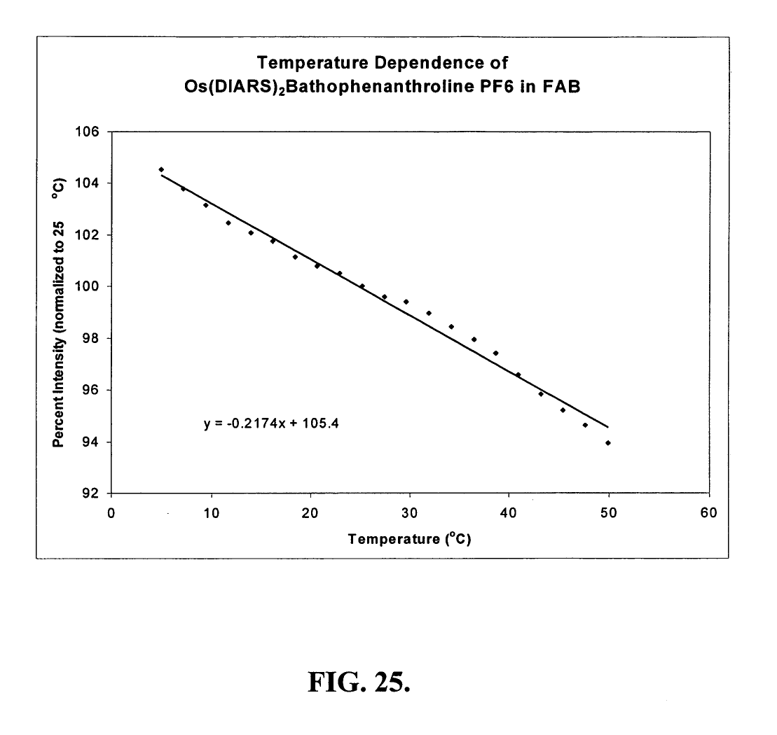

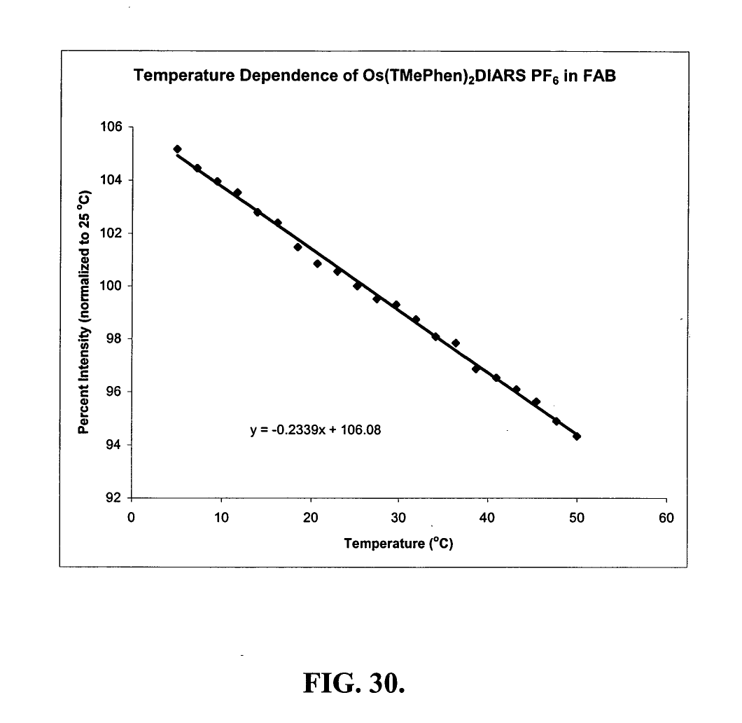

The temperature dependence of emission for the complexes in FAB are shown in FIGS. 19, 25, and 30, respectively.

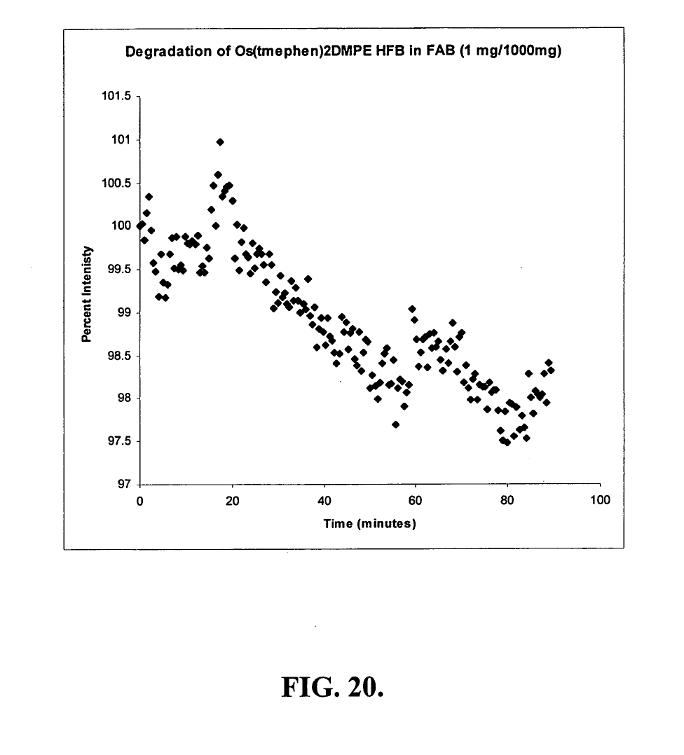

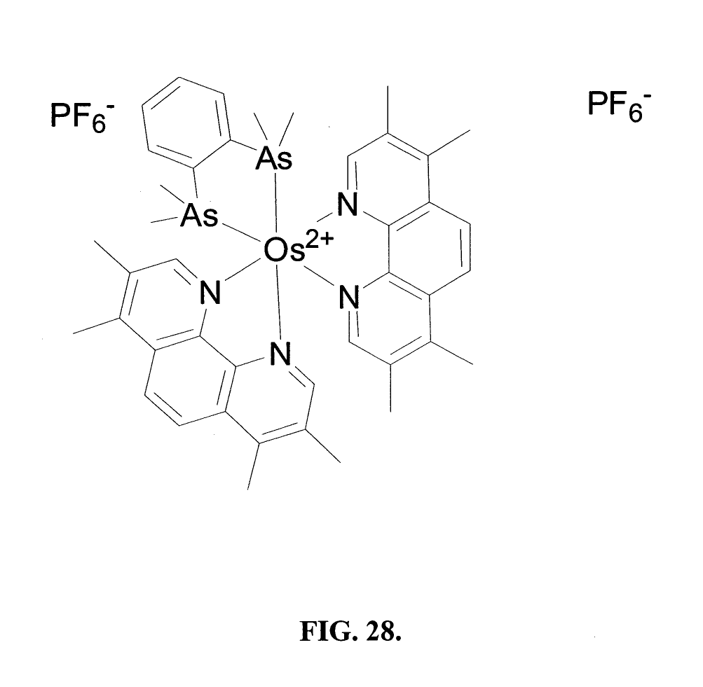

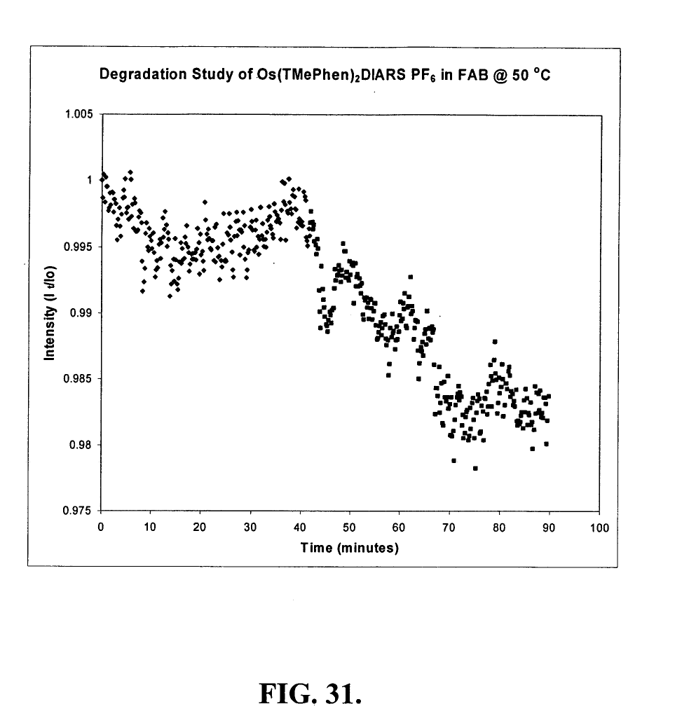

The degradation of emission for the complexes illustrated in FIGS. 17 and 28 in FAB are shown in FIGS. 20 and 31, respectively.

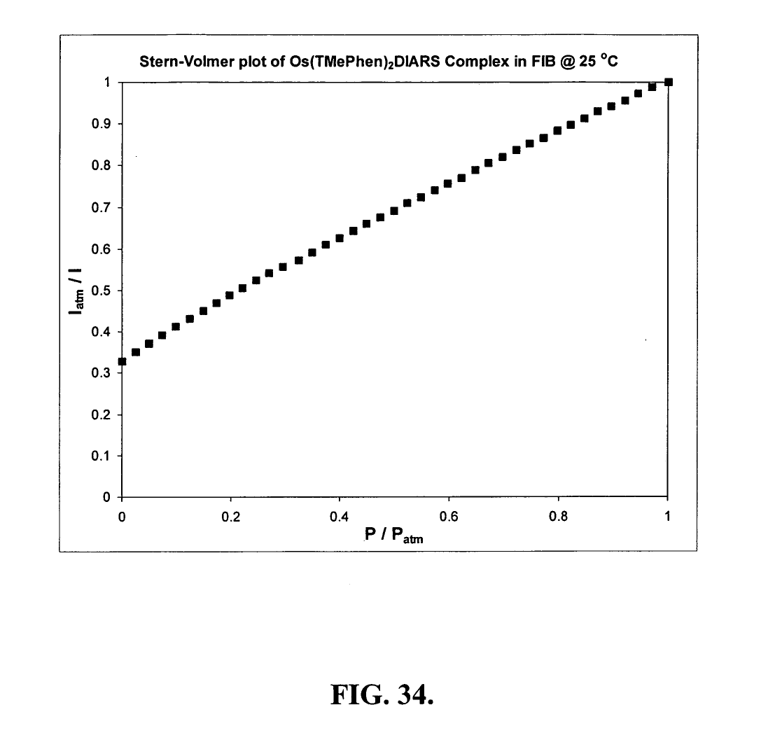

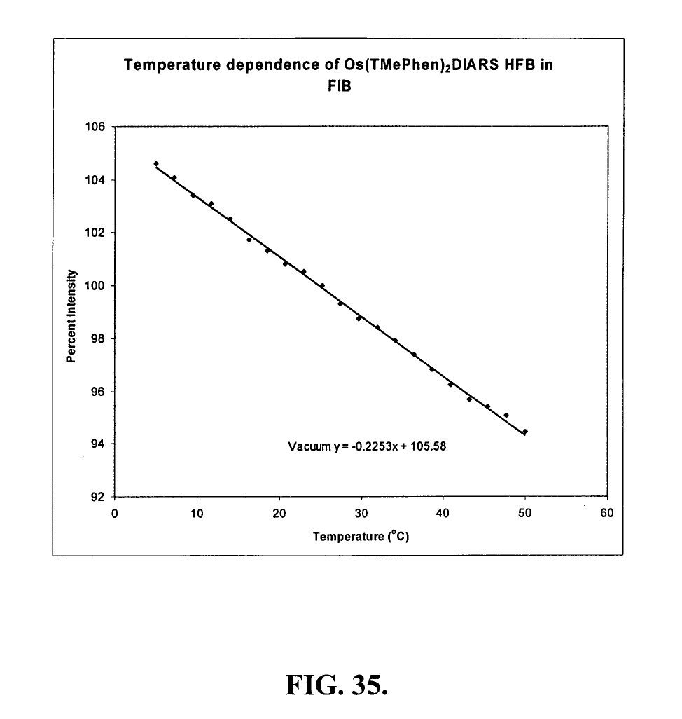

Stem-Volmer plots and the temperature dependence of emission for osmium (3,4,7,8-tetramethyl-1,10-phenanthroline)₂1,2-phenylenebis(dimethylarsine)heptafluorobutyrate in FIB are shown in FIGS. 34 and 35, respectively.

### EXAMPLES

General procedure for synthesis of osmium complexes. The osmium complexes were synthesized by reacting 1.000 g (2.08 mmol) of (NH₄)₂OsCl₆ (Alfa) with 2.05 equivalents of polypyridyl (N—N) ligand in 25 mL of refluxing DMF (Aldrich) under inert atmosphere for 3 hours. The resulting solution was filtered, washed with DMF, cooled to 0° C., and then added dropwise to a water solution of sodium dithionite (2.00 g in 400 mL) at 0° C. The resulting purple precipitate of Os(N—N)₂Cl₂ was filtered and washed with deionized water. Os(N—N)₂Cl₂ was reacted with 1.05 eq. of cis-1,2vinylenebis(dipheylarsine) (dpaene, x-ray structure illustrated as FIG. 4) or cis-1,2-vinylenebis(diphenylphosphine) (dppene) ligand in a refluxing mixture of 2,2′-ethoxyethoxyethaonol (Aldrich) and glycerol (75:25 by volume) for 2 hours under inert atmosphere. The complexes were precipitated by dropwise addition to a saturated water solution of KPF₆, filtered, and washed with water. Complexes were then purified on silica using either toluene/acetonitrile or acetonitrile/water/KPF₆ solvent systems. The structures of the resulting complexes are shown in FIG. 3, and the crystal structures of complexes 2 and 6 are illustrated in FIGS. 5 and 6, and complexes 1, 3, 5 are illustrated in FIGS. 7-9.

Elemental analysis: Complex 1: Calculated: C, 45.33; H, 2.89; N, 4.23. Found: C, 45.50; H, 2.79; N, 4.33. Yield: 72%. Complex 2: Calculated: C, 48.55; H, 3.10; N, 4.53. Found: C, 48.15; H, 2.99; N, 4.58. Yield: 68%. Complex 3: Calculated: C, 53.55; H, 3.57; N, 3.20. Found: C, 53.50; H, 3.60; N, 3.20. Yield: 89%. Complex 4: Calculated: C, 56.39; H, 3.76; N, 3.37. Found: C, 56.47; H, 3.61; N, 3.46. Yield: 92%. Complex 5: Calculated: C, 48.47; H, 3.79; N, 3.90. Found: C, 48.53; H, 3.75; N, 3.95. Yield: 54%. Complex 6: Calculated: C, 51.63; H, 4.03; N, 4.15. Found: C, 51.39; H, 4.00; N, 4.11. Yield: 46%.

Polymerization of Poly(2-[ethyl[(heptadecafluorooctyl)-sulfonyl]amino]-ethylmethacrylate) (FAB). (2-[ethyl[(heptadecafluorooctyl)-sulfonyl]amino]-ethylmethacrylate) (50 g) was purchased from Aldrich and used without further purification. The compound was added to a flask with 150 mL of α,α,α-trifluorotoluene and 1.0 g of lauroyl peroxide (Aldrich). The system was purged with argon and then heated to 75° C. for 48 hours. The raw polymer liquor was precipitated in a 60/40 mixture of hexanes/methylene chloride at 0° C. The compound was then dissolved in α,α,α-trifluorotoluene, and then precipitated in a 60/40 mixture of hexanes/methylene chloride at 0° C. The resulting FAB powder was filtered and allowed to air dry, and dried under vacuum at 40° C.

X-Ray Diffraction. Crystals of dpaene were grown from heptane at room temperature. Crystals of osmium complexes were grown by dissolving the complex in methylene chloride and layering diethyl ether on top, or by 1:3 mixtures of acetonitire:toluene. The crystals were mounted in a random orientation on a glass fiber on a KAPPA CCD Diffractometer using Mo Kα (λ=0.71073 Å) radiation. Measurements were performed at 130+/−2 K. Cell constants and an orientation matrix for data collections were obtained by least squares refinements of the diffraction data from up to 141,517 full and partial reflections. The structures were solved by direct methods using SIR97 and DIRDIFF, provided by the refinement package MaXus. Missing atoms were found by difference-Fourier synthesis. The non-hydrogen atoms were refined with anisotropic temperature factors. Scattering factors are from Waasmaier and Kirfel. The structures were refined with SHELXL-97 and ortep plots were generated with ORTEP32. Table 1 summarizes the crystal data, collection information, and refinement data for these structures.

Quantum Yield Measurements: Photoluminescence (PL) quantum yields to +/−10% of the Os complexes (φ_{Os}) in ethanol solutions were obtained using RU(II) tris(4,7-diphenyl-1,10-phenanthroline) dichloride as the standard, which has a known quantum yield of 0.366, using the following equation:

$${Φ}_{Os} = \frac{abs Ru}{area Ru} \times \frac{area Os}{abs Os} \times 0.366 \qquad ( 1 )$$

Samples were excited through the LC state at 280 nm with absorption of 0.150. Temperature for the measurements was 25° C.+/−2° C.

Preparation of PSP. Osmium complex (1.0 mg) was added to a 25 mL vial and 2.0 ml of acetone was added and dissolved the complex. To this was added 1.0 g of FAB and 20 mL of α,α,α-trifluorotoluene. Both the polymer and the complexes were readily soluble in the solvent. The solutions were airbrushed onto 1 in² aluminum plates that had been polished and cleaned with acetone.

Testing of PSP. The films were tested in a survey apparatus of custom design described in Reference 31. This apparatus simultaneously monitors, and controls pressure, temperature, and luminescence intensity. The thickness of the tested films was 15 microns as measured by a Tencor P-15 profilometer.

TABLE 1
Crystollographic data for the structures provided.

| Property | DPAENE | 1 | 2 | 3 |
|---|---|---|---|---|
| Empirical Formula | C₂₆H₂₂As₂ | 2(C₅₀H₃₈As₂N₄Os),0.69(C₁₄H₁₆),3(C₂H₃N),4(F₆P) | C₅₃H₄₄Cl₆F₁₂N₄OsP₄ | C₉₇H₈₁As₂Cl₁₅N₄O₁₀OsS₂ |
| Formula Weight | 484.28 | 1432.47 | 1491.70 | 2398.57 |
| Temperature K | 130(2) | 130(2) | 130(2) K | 130(2) |
| Wavelength Å | 0.71073 | 0.71073 | 0.71073 | 0.71073 |
| Crystal/color | Cut block/ | Prism/orange | cut-block/red | Cut block/orange |
| | colorless | | | |
| Crystal System, | Monoclinic, | Triclinic, P-1 | Triclinic, P-1 | Triclinic, P-1 (No2) |
| space group | P c (No7) | | | |
| Unit Cell Dimensions | | | | |
| a, Å | 12.5970(3) | 12.0330(2) | 11.9760(12) | 15.6190(7) |
| b, Å | 5.61500(10) | 13.6250(3) | 13.1660(17) | 16.3000(4) |
| c, Å | 17.0450(5) | 19.5740(5) | 20.256(3) | 21.0090(9) |
| α, deg | 90.00 | 99.0570(7) | 95.551(6) | 71.386(2) |
| β, deg | 117.1660(11) | 97.3220(7) | 99.932(5) | 75.8890(14) |
| γ, deg | 90 | 112.9261(11) | 113.176(4) | 84.734(2) |
| Volume (Å \hat{ }3) | 1072.63(4) | 2855.25(11) | 2843.9(6) | 4915.4(3) |
| Density Mg/m\hat{ }3 | 1.499 | 1.666 | 1.742 | 1.621 |
| Reflections | 4454/3739 | 12528/8605 | 14977/9393 | 18382/11398 |
| Collected/Unique | | | | |
| Final R indices | | | | |
| [I > 2sigma(I)] | | | | |
| R1 | 0.0576 | 0.0549 | 0.0705 | 0.0595 |
| wR2 | 0.1505 | 0.1318 | 0.1291 | 0.1514 |
| R indices (all data) | | | | |
| R1 | 0.0732 | 0.0950 | 0.2037 | 0.0747 |
| wR2 | 0.1401 | 0.1516 | 0.1672 | 0.1607 |

| Property | 5 | 6 | DMB |
|---|---|---|---|
| Empirical Formula | C₆₀H₅₈As₂Cl₄F₁₂N₄OsP₂ | C₆₅H₆₂F₁₂N₄OsP₄ | C₅₁H_{47.5}As₂Cl₂F₁₂N₄OsP₂ |
| Formula Weight | 1606.88 | 1441.27 | 1417.31 |
| Temperature K | 130(2) | 130(2) | 130(2) |
| Wavelength Å | 0.71073 | 0.71073 | 0.71073 |
| Crystal/color | Cut block/orange | plate/red | Plate/orange |
| Crystal System, | Monoclinic, P 21/c | Monoclinic, P 21/c | Monoclinic, C 2/c |
| space group | | | |
| Unit Cell Dimensions | | | |
| a, Å | 13.2030(2) | 15.3740(5) | 48.5050(2) |
| b, Å | 13.6150(2) | 14.2610(6) | 11.4120(3) |
| c, Å | 37.3350(5) | 28.9730(11) | 20.1190(5) |
| α, deg | 90 | 90 | 90 |
| β, deg | 109.0581(5) | 105.611(2) | 103.0440(7) |
| γ, deg | 90 | 90 | 90 |
| Volume (Å \hat{ }3) | 6343.44(16) | 6118.0(4) | 10849.3(4) |
| DensityMg/m\hat{ }3 | 1.683 | 1.565 | 1.735 |
| Reflections | 26446/14579 | 20796/11404 | 33470/11604 |
| Collected/Unique | | | |
| Final R indices | | | |
| [I > 2sigma(I)] | | | |
| R1 | 0.0574 | 0.0630 | 0.0547 |
| wR2 | 0.1006 | 0.1420 | 0.1273 |
| R indices (all data) | | | |
| R1 | 0.1553 | 0.1369 | 0.0924 |
| wR2 | 0.1285 | 0.1819 | 0.1440 |

TABLE 2
C—As—C bond angles (deg) for complex
for dpaene and osmium complexes.

| | | | C(Ph)-As(1)- |
|---|---|---|---|
| compound | C(Ph)-As(1)-C(br) | C(Ph)-As(1)-C(br) | C(Ph) |
| dpaene | 99.7(3) | 96.1(3) | 97.6(3) |
| 1 | 103.7(3) | 102.7(3) | 103.2(3) |
| 3 | 102.4(4) | 104.2(4) | 104.0(4) |
| 5 | 102.3(3) | 103.4(3) | 100.5(3) |
| DMB | 103.4(3) | 103.5(3) | 100.0(3) |
| DPB | 103.7(5) | 103.6(5) | 101.3(4) |
| | | | C(Ph)-As(2)- |
| Complex | C(Ph)-As(2)-C(br) | C(Ph)-As(2)-C(br) | C(Ph) |
| dpaene | 97.0(3) | 98.4(3) | 96.6(3) |
| 1 | 106.5(3) | 102.2(3) | 101.8(3) |
| 3 | 102.2(4) | 101.3(4) | 102.4(4) |
| 5 | 102.2(3) | 102.1(3) | 104.6(3) |
| DMB | 105.8(3) | 101.9(3) | 101.7(3) |
| DPB | 104.8(5) | 102.6(5) | 102.4(5) |

br = bridge,
Ph = phenyl
DMB = [Os(4,4′-dimethyl-2,2′-bipyridine)₂(dpaene)]²⁺2(PF₆⁻)
DPB = [Os(4,4′-diphenyl-2,2′-bipyridine)₂(dpaene)]²⁺2(Ts⁻)

TABLE 3
Bond lengths for free ligand, dpaene, and osmium complexes (Å).

| Complex | N1 | N2 | N3 | N4 | As1 | As2 |
|---|---|---|---|---|---|---|
| 1 | 2.133(5) | 2.091(5) | 2.133(5) | 2.086(5) | 2.4088(6) | 2.4056(7) |
| 3 | 2.088(7) | 2.102(6) | 2.098(6) | 2.077(7) | 2.4122(7) | 2.4108(8) |
| 5 | 2.109(5) | 2.088(5) | 2.075(5) | 2.100(5) | 2.4130(7) | 2.4129(7) |
| DMB | 2.079(6) | 2.099(6) | 2.092(5) | 2.092(6) | 2.4000(7) | 2.4068(7) |
| DPB | 2.054(9) | 2.094(8) | 2.011(11) | 2.057(9) | 2.3997(15) | 2.4200(15) |

| Arsenic | As(1)-C(br) | As(1)-C(Ph) | As(1)-C(Ph) | As(2)-C(br) | As(2)-C(Ph) | As2-C(Ph) |
|---|---|---|---|---|---|---|
| dpaene | 1.946(8) | 1.951(7) | 1.979(7) | 1.953(7) | 1.959(8) | 1.969(7) |
| 1 | 1.944(7) | 1.952(7) | 1.955(7) | 1.948(6) | 1.945(6) | 1.948(6) |
| 3 | 1.952(8) | 1.939(7) | 1.932(7) | 1.939(7) | 1.935(7) | 1.935(8) |
| 5 | 1.938(7) | 1.937(7) | 1.921(7) | 1.928(6) | 1.921(7) | 1.943(6) |
| DMB | 1.936(8) | 1.953(7) | 1.943(7) | 1.945(7) | 1.941(7) | 1.942(7) |
| DPB | 1.932(11) | 1.930(10) | 1.945(11) | 1.929(9) | 1.944(11) | 1.941(11) |

br = bridge,
Ph = phenyl
DPB = [Os(4,4′-diphenyl-2,2′-bipyridine)2(dpaene)]²⁺2(Ts⁻)

TABLE 4
Spectral properties of the various complexes

| Com- | | ¹MLCT | ³MLCT | Emis- | | |
|---|---|---|---|---|---|---|
| plex | LC (nm) (ε) | [symbol] | [symbol] | sion^{a} | τ ns^{b} | ^{Φc} |
| 1 | 267 (52,000) | 384 (12,000) | 500 (2,400) | 606 | 1580 | 0.20 |
| 2 | 267 (57,000) | 376 (13,000) | 480 (3,000) | 595 | 1840 | 0.20 |
| 3 | 273 (71,000) | 391 (39,000) | 500 (8,000) | 629 | 1550 | 0.45 |
| 4 | 269 (69,000) | 364 (50,000) | 487 (9,000) | 611 | 1970 | 0.36 |
| 5 | 276 (68,000) | 377 (17,000) | 450 (5,000) | 588 | 2800 | 0.26 |
| 6 | 277 (51,000) | 367 (13,000) | 441 (4,000) | 572 | 3400 | 0.17 |

^{a}nanometers,
^{b}emission lifetime,
^{c}emission quantum yield

TABLE 5
PSP properties of the various complexes.

| | | Temperature | |
|---|---|---|---|
| | | dependence | Degradation |
| Complex | Dynamic Range | (%/°C.) | (%/90 min) |
| 1 | 0.19 | −0.27 | 0.0 |
| 2 | 0.19 | −0.59 | 0.2 |
| 3 | 0.22 | −0.17 | 0.2 |
| 4 | 0.25 | −0.43 | 0.5 |
| 5 | 0.50 | −0.20 | 0.0 |
| 6 | 0.50 | −0.86 | 0.8 |
| RuBth | 0.55 | −1.4 | 5.9 |

### REFERENCES

Each reference is expressly incorporated herein by reference in its entirety.
Albinati, A., et al., Inorg. Chim. Acta, 259(1-2):351, 1997.
Alford, P., et al., J. Chem. Soc. Perkin Trans. II, 5:705, 1985.
Amao, Y., et al., Anal. Chim. Acta, 445:177, 2001.
Asai, K., et al., J. Thermophys. Heat Transfer, 16(1):109, 2002.
Baron, A. E., University of Washington Doctoral Thesis: “On Time- and Spatially-Resolved Measurements of Luminescence-Based Oxygen Sensors (Pressure Sensitive Paint).” 1996, 201 pp.
Basu, B. J. and K. S. Rajam, Sensors and Actuators, B: Chemical, B99(2-3), 459 2004.
Berners-Price, S. J., et al., J. Chem. Soc., Dalton Trans., 23:3357, 1992.
Bowman, R. D., et al., J. Microscop., 211(2):112, 2003.
Carlson, B., et al., Inorg. Chim. Acta, 357:3967, 2004.
Carlson, B., et al., J. Am. Chem. Soc., 124(47):14162, 2002.
Carlson, B., et al., Polym. Prepr., 43:590, 2002.
Cole, W., Boeing Frontiers Online, 2002, 1(1).
Costa-Fernandez, J. M., et al., Anal. Chim. Acta, 360(1-3):17, 1998.
Cotton, F. A., et al., Advance Inorganic Chemistry, Sixth Edition, Wiley-Interscience, New York, 1999, 642.
DeRosa, M. C., et al., J. Amer. Chem. Soc., 126(24):7619, 2004.
Duell, E., et al., Society of Automotive Engineers, Inc. Paper 2001-01-0626, 2001.
Dunne, B. J., et al., J. Chem. Soc., Dalton Trans. 1991, 653.
Farrugia, L. J., Appl. Cryst., 30:565, 1997.
Gao, R., et al., J. Am. Chem. Soc., 124:14828, 2002.
Gouin, S. and M. Gouterman, J. App. Poly. Sci., 77(13):2815, 2000.
Gouterman, M., et al., Meas. Sci. and Tech., 15(10):1986, 2004.
Hartmann, P., Anal. Chem., 72(13):2828, 2000.
Heinemann, F. W., et al., Zeit. fuer Krist., 211(6):388, 1996.
Huheey, J. E., et al., Inorganic Chemistry: Principles of Structure and Reactivity, 4th Edition, Harper Collins, New York, 1993, 489.
Ji, H-F., et al., Appl. Spect., 54(6):856, 2000.
Jiang, F., et al., Gongneng Cailiao, 31(1):72, 2000.
Jiang, F-Z., et al., J. Mat. Res., 17(6):1312, 2002.
Jones, P. C. and M. C. Gimeno, Zeit. Fur Krist., 209:688, 1994.
Juris, A., et al., Coordina. Chem. Rev. 84, 85, 1988.
Khalil, G. E., et al., Sens. and Actu., B: Chem., B97(1):13, 2004.
Kober, E., et al., Inorg. Chem., 27:4587, 1988.
Kober, E. M., et al., Inorg. Chem., 24:2755, 1985.
Kraatz, H. B., et al., Organometallics, 12:76, 1993.
Mackay, S., et al., MaXus, University of Glasgow, Scotland, 1997.
Marynick, D. S., J. Amer. Chem. Soc., 106(14):4064-5, 1984.
McMurray, H. N., et al., J. Photochem. Photobio., A: Chem., 80(1-3):283, 1994.
Mingoarranz, F. J., et al., Mikrochimica Acta, 121(1-4):107-18, 1995.
Morris, R. J. and G. S. Girolami, Inorg. Chem., 29(21):4167, 1990.
Norman, N. C., Chemistry of Arsenic, Antimony, and Bismuth, Blackie Academic: London, 1998.
Ogurtsov, V. I. and D. B. Papkovsky, Sen. and Act., B: Chem., B88(1):89, 2003.
Ohki, Y. and H. Suzuki, Ange. Chem., Inter. Ed., 41(16):2994, 2002.
Orpen, A. G., and N. G. Connelly, J. Chem. Soc., Chem. Commun., 19:1310, 1985.
Orpen, A. G., and N. G. Connelly, Organometallics, 9(4): 1206, 1990.
Pacchioni, G. and P. S. Bagus, Inorg. Chem., 31(21):4391, 1992.
Potyrailo, R. A. and G. M. Hieftje, Fresenius' J. Anal. Chem., 364(1-2):32, 1999.
Puklin, E., et al., J. App. Poly. Sci., 77(13):2795, 2000.
Sakaue, H., et al., AIAA J., 40(6):1094, 2002.
Schael, F., et al., Chemie Ingenieur Technik, 73(4):381, 2001.
Schanze, K. S., et al., AIAA J., 35(2):306, 1997.
Vander-Donckt, E., et al., Bull. Soc. Chim. Belg., 103:207, 1994.
Waasmaier, D., and A. Kirfel, A., Acta Crystallogr. A., 51:416, 1995.
Wallace, L. and D. P. Rillema, Inorg. Chem., 32:3836, 1993.
Wendt, O. F. and L. I. Elding, J. Chem. Soc., Dalton Trans., 24:4725, 1997.
Wendt, O. F., et al., Inorg. Chim. Acta, 277:237, 1998.
Wulfsberg, G., Principles of Descriptive Inorganic Chemistry, University Science Books, Mill Valley, Calif., 1991, 447.
Xavier, M. P., et al., Anal. Chem., 70(24):5184, 1998.

1. A composition, comprising:
(a) a luminescent osmium complex having the formula
[Os(II)(N—N)₂L-L]²⁺, 2A⁻ or A²⁻
wherein Os(II) is divalent osmium;
N—N is a substituted or unsubstituted 1,10-phenanthroline ligand;
L-L is cis-1,2-bis(diphenylarseno)ethylene, or cis-1,2-bis(diphenylphosphino)ethylene; and
A is a counter ion; and
(b) an oxygen-permeable host material.

2. The composition of claim 1, wherein N—N is 1,10-phenanthroline.

3. The composition of claim 1, wherein N—N is 4,7-bis(p-methoxyphenyl)-1,10-phenanthroline.

4. The composition of claim 1, wherein N—N is 3,4,7,8-tetramethyl-1,10-phenanthroline.

5. The composition of claim 1, wherein the host is poly(2-[ethyl[(heptadecafluorooctyl)sulfonyl]amino]ethylmethacrylate).

6. A method for measuring the pressure of an oxygen-containing fluid on a surface, comprising:
flowing an oxygen-containing fluid over a surface coated with a composition comprising:
(a) a luminescent osmium complex having the formula
[Os(II)(N—N)₂L-L]²⁺, 2A⁻ or A²⁻
wherein Os(II) is divalent osmium;
N—N is a substituted or unsubstituted 1,10-phenanthroline ligand;
L-L is cis-1,2-bis(diphenylarseno)ethylene, or cis-1,2-bis(diphenylphosphino)ethylene; and
A is a counter ion; and
(b) an oxygen-permeable host material;
illuminating at least a portion of the surface with light having a wavelength sufficient to effect luminescent emission from the osmium complex; and
measuring the luminescent emission intensity of the osmium complex.

7. The method of claim 6, wherein the surface is an aerodynamic surface.

8. The method of claim 6, wherein the surface is an airfoil, rotor, propeller, fixed-wing, turbine blade, nacelle, aircraft, or missile.
